(19) United States
(12) Patent Application Publication
(10) Pub. No.: US 2020/0273023 A1
(43) Pub. Date: Aug. 27, 2020

(54) METHOD AND SYSTEM FOR REDEEMING VOUCHERS

(71) Applicant: MASTERCARD INTERNATIONAL INCORPORATED, Purchase, NY (US)

(72) Inventors: Sudhir Gupta, Pune (IN); Rahul Agrawal, Pune (IN); Harsh Piparsaniya, Pune (IN)

(73) Assignee: MASTERCARD INTERNATIONAL INCORPORATED, Purchase, NY (US)

(21) Appl. No.: 16/797,915

(22) Filed: Feb. 21, 2020

(30) Foreign Application Priority Data
Feb. 22, 2019 (SG) 10201901547Q

(51) Int. Cl. G06Q 20/38; G06Q 30/02; G06Q 20/40

(52) U.S. Cl. CPC G06Q 20/387; G06Q 20/405; G06Q 30/0225

(57) ABSTRACT

A method for redeeming vouchers includes receiving, by a server, a voucher redemption request for redeeming a voucher and a first set of purchase requests for a first set of purchases. The voucher is associated with a voucher value. When the voucher is a discount voucher, the voucher value is a minimum purchase amount, and when the voucher is a gift voucher, the voucher value is a gift amount. The server selects one or more purchase requests from the first set of purchase requests such that a sum of purchase amounts associated with the selected one or more purchase requests is greater than or equal to the voucher value. The server initiates a redemption of the voucher against the selected one or more purchase requests.

### FIELD OF THE INVENTION

The present invention relates to the field of electronic transactions, and, more particularly to a method and a system for redeeming vouchers.

### BACKGROUND

Market share is a key performance metric for measuring business growth for any business. Hence, most business strategies of businesses of various business owners, including merchants, are aimed at increasing the market share of the businesses. Examples of various business strategies adopted by the merchants include competitive pricing, enhanced marketing communications, or distribution of vouchers. From these business strategies, distributing vouchers to users is the most common approach adopted by the merchants to entice users. For example, a user, who has a voucher for a first apparel brand, will check the first apparel brand prior to checking other apparel brands when the user wants to purchase clothes. In one scenario, a merchant may distribute a voucher to a user as a reward for a prior engagement of the user therewith or as a business promotion offer. In another scenario, the merchant may freely distribute or sell the voucher to potential users. Typically, a voucher may be categorized into one of two types—a discount voucher and a gift voucher. A discount voucher provided by a merchant to a user allows the user to avail a discount on a purchase made by the user. Similarly, a gift voucher allows the user to pay for a purchase either completely or in parts.

Often, the discount voucher is associated with a minimum purchase amount. For a user to be able to redeem the discount voucher against a purchase, a purchase amount of the purchase must be greater than the minimum purchase amount. For example, a discount voucher may allow a user to avail a discount of ‘$20’ on a purchase worth ‘$100’ or more. Many a times, a purchase amount of a purchase made by a user may be less than the minimum purchase amount associated with the discount voucher and the user may not be inclined towards purchasing more products and/or services just to be able redeem the discount voucher. In such a scenario, the user is unable to redeem the discount voucher, thereby causing inconvenience to the user. In addition to this, the user may not be permitted to redeem the gift voucher without making a purchase. In other words, the user may not be permitted to encash the gift voucher.

In light of the foregoing, there is a need for a technical solution that allows a user to redeem a gift voucher for cash and redeem a discount voucher even when a purchase amount of a purchase made by the user is less than a minimum purchase amount associated with the discount voucher.

### SUMMARY

In an embodiment of the present invention, a method for redeeming vouchers is provided. The method includes receiving, by a server, a first set of purchase requests for a first set of purchases and a voucher redemption request for redeeming a voucher against a first purchase request. The voucher is associated with a voucher value. One or more purchase requests are selected by the server from the first set of purchase requests. The one or more purchase requests are selected such that a sum of a first purchase amount associated with the first purchase request and one or more purchase amounts associated with the selected one or more purchase requests, respectively, is greater than or equal to the voucher value. The one or more purchase requests are selected when the voucher value is greater than the first purchase amount. Redemption of the voucher is initiated, by the server, against the first purchase request and the selected one or more purchase requests.

In another embodiment of the present invention, a system for redeeming vouchers is provided. The system includes a server that is configured to receive a first set of purchase requests for a first set of purchases and a voucher redemption request for redeeming a voucher against a first purchase request. The voucher is associated with a voucher value. The server selects, from the first set of purchase requests, one or more purchase requests such that a sum of a first purchase amount associated with the first purchase request and one or more purchase amounts associated with the selected one or more purchase requests, respectively, is greater than or equal to the voucher value. The one or more purchase requests are selected when the voucher value is greater than the first purchase amount. The server initiates redemption of the voucher against the first purchase request and the selected one or more purchase requests.

In yet another embodiment of the present invention, a method for redeeming vouchers is provided. The method includes receiving, by a server, a first set of purchase requests initiated by a first set of users and a voucher redemption request initiated by a first user for redeeming a voucher. The voucher is associated with a voucher value. One or more purchase requests are selected by the server from the first set of purchase requests. The one or more purchase requests are selected such that a sum one or more purchase amounts associated with the selected one or more purchase requests, respectively, is greater than or equal to the voucher value. The voucher is redeemed, by the server, against the selected one or more purchase requests. A first part of the voucher value is credited to a first user account of the first user when the voucher is redeemed.

### BRIEF DESCRIPTION OF THE DRAWINGS

Various embodiments of the present invention are illustrated by way of example, and not limited by the appended figures, in which like references indicate similar elements, and in which:

FIG. 1 is a block diagram that illustrates an exemplary environment for redeeming vouchers, in accordance with an embodiment of the present invention;

FIGS. 2A-2F, collectively represent a process flow diagram that illustrates an exemplary scenario for redeeming a discount voucher, in accordance with an embodiment of the present invention;

FIGS. 3A-3F, collectively represent another process flow diagram that illustrates another exemplary scenario for redeeming a gift voucher, in accordance with another embodiment of the present invention;

FIGS. 4A and 4B represent an exemplary scenario that illustrates user interface (UI) screens rendered by a service application of FIG. 1, in accordance with an embodiment of the present invention;

FIG. 5 is a block diagram that illustrates a payment network server of FIG. 1, in accordance with an embodiment of the present invention;

FIGS. 6A-6E, collectively represent a flow chart that illustrates a method for redeeming vouchers, in accordance with an embodiment of the present invention;

FIG. 7 represents a high-level flow chart that illustrates the method for redeeming vouchers, in accordance with an embodiment of the present invention;

FIG. 8 represents a high-level flow chart that illustrates the method for redeeming vouchers, in accordance with another embodiment of the present invention; and

FIG. 9 is block diagram that illustrates system architecture of a computer system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the present invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

A first user may attempt to redeem a discount voucher against a purchase made by the first user. The discount voucher may be associated with a minimum purchase amount. In a scenario where a purchase amount of the purchase is less than the minimum purchase amount, the first user may not be able to redeem the discount voucher against the purchase. Further, the first user may not be allowed to encash a gift voucher. Thus, the first user is inconvenienced.

Various embodiments of the present invention provide a method and a system that solve the abovementioned problems by enabling the first user to redeem the discount voucher even when the purchase amount of the purchase is less than the minimum purchase amount. Further, the method and the system allow the first user to encash the gift voucher. The first user may access, by way of a first user device, a service application hosted by a server to initiate a first purchase request for a first purchase. Examples of the server may include, but are not limited to, a payment network server, a merchant server, an issuer server, or the like. The server provides a voucher redemption service (VRS) by way of the service application. The service application may serve as a gateway to the server; thus, the server receives the first purchase request. The first purchase request is indicative of a first purchase amount of the first purchase.

In one embodiment, the first user initiates a first voucher redemption request, by way of the service application, for redeeming a discount voucher against the first purchase. The server receives the first voucher redemption request. The first voucher redemption request includes voucher details of the discount voucher. The voucher details of the discount voucher include a first voucher identifier and a minimum purchase amount (i.e., a voucher value) of the discount voucher. The server validates the discount voucher based on the voucher details of the discount voucher. When the first purchase amount is less than the minimum purchase amount, the server selects other purchase requests such that a sum of the first purchase amount and purchase amounts corresponding to the selected purchase requests is greater than or equal to the minimum purchase amount. The selected purchase requests may correspond to purchases initiated by other users using the service application. The server determines a discount applicable on each of the selected purchase requests and the first purchase request, based on a discount amount associated with the discount voucher. The server communicates the applicable discounts to the users corresponding to the selected purchase requests for their approval. Based on the approval from the users, the server clubs the purchases corresponding to the selected purchase requests and the first purchase, and redeems the discount voucher against the first purchase request and the selected purchase requests.

In another embodiment, the first user initiates a second voucher redemption request, by way of the service application, for redeeming a gift voucher against the first purchase. The server receives the second voucher redemption request. The second voucher redemption request includes voucher details of the gift voucher. The voucher details of the gift voucher include a second voucher identifier and a gift amount (i.e., a voucher value) of the gift voucher. The server validates the gift voucher based on the voucher details of the gift voucher. When the first purchase amount is less than the gift amount, the server selects other purchase requests such that a sum of the first purchase amount and purchase amounts corresponding to the selected purchase requests is greater than or equal to the gift amount. The selected purchase requests may correspond to purchases initiated by users using the service application. The server determines a share of the gift amount applicable on each of the selected purchase requests and the first purchase request. The server communicates the applicable share to the users corresponding to the selected purchase requests for their approval. Based on the approval from the users, the server clubs the purchases corresponding to the selected purchase requests and the first purchase, and redeems the gift voucher against the first purchase request and the selected purchase requests. The server may credit a first amount to a user account of the first user based on the redemption of the gift voucher. The first amount may correspond to a sum of the shares of the gift amount applicable on the selected purchase requests.

Thus, the method and system of the present invention enable the first user to redeem the discount voucher even when the first purchase amount is less than the minimum purchase amount associated with the discount voucher. The method and system further enable the first user to encash the gift voucher.

### Terms Description (in Addition to Plain and Dictionary Meaning)

Voucher is a physical or digital coupon that allows a user to claim monetary benefits (such as discounts) when redeemed against a purchase of products and/or services. The voucher may be a discount voucher or a gift voucher.

Discount voucher is a voucher that allows a user to avail a discount on a purchase when the user redeems the discount voucher. The discount voucher is typically associated with a minimum purchase amount (i.e., a voucher value of the discount voucher) and a discount amount. For example, a discount voucher may be associated with a minimum purchase amount of ‘$4,000’ and a discount amount of ‘$500’. This implies that the user may redeem the discount voucher to avail a discount of ‘$500’ on a purchase if a purchase amount of the purchase is greater than or equal to ‘$4,000’.

Minimum purchase amount is a minimum amount of money that needs to be spent by a user, on a purchase, to be able to redeem a voucher against the purchase. For example, a discount voucher may be associated with a minimum purchase amount equal to ‘$4,000’ and a discount amount equal to ‘$500’. This implies that the user may be able redeem the discount voucher if a purchase amount of a purchase is greater than or equal to ‘$4,000’.

Gift voucher is a voucher that may be redeemed by a user to pay for a purchase either completely or in parts. The gift voucher may be associated with a gift amount (i.e., a voucher value of the gift voucher). If the gift amount is greater than or equal to a purchase amount of the purchase, the user may not need to pay for the purchase when the gift voucher is redeemed. If the purchase amount of the purchase is greater than the gift amount, the user may be required to pay only an amount equal to a difference between the purchase amount and the gift amount. For example, the gift amount may be equal to ‘$500’ and the purchase amount may be equal to ‘$450’. In such a scenario, the user may simply redeem the gift voucher against the purchase and may not need to pay for the purchase.

Purchase request is a request that is generated based on a purchase initiated by a user from a merchant. The purchase request may indicate a purchase amount of the purchase, a purchase category of the purchase, or the like. For example, a first purchase request may be generated when the user initiates a first purchase of a mobile phone from the merchant. The first purchase request may indicate a first purchase amount (i.e., a price of the first mobile phone), a purchase category (say, ‘Electronics’), or the like.

Voucher identifier is a code (such as a numeric or an alpha-numeric code) that uniquely identifies a voucher, e.g., a gift voucher or a discount voucher. For example, a first voucher identifier of a first voucher may be ‘X425GH’.

Issuer is a financial institution which establishes and maintains user accounts of several users. The issuer authorizes and settles transactions in accordance with various payment network regulations and local legislation.

Payment networks, such as those operated by Mastercard®, process transactions between acquirers and issuers. Processing by a payment network includes steps of authorization, clearing, and settlement.

Server is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. The server may correspond to one of an acquirer server, a payment network server, or an issuer server.

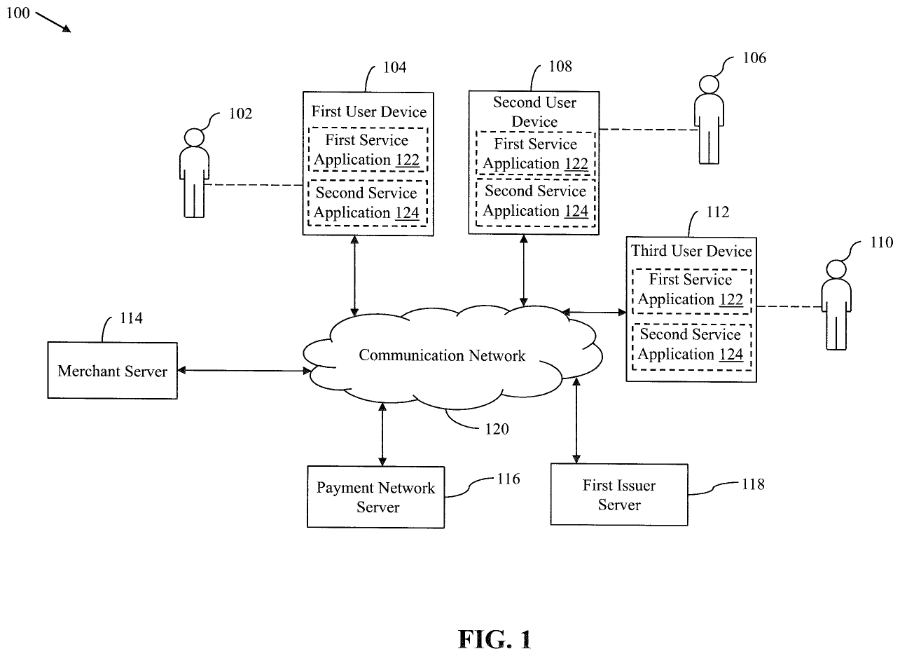

FIG. 1 is a block diagram that illustrates an exemplary environment 100 for redeeming vouchers, in accordance with an embodiment of the present invention. The environment 100 includes a first user 102 in possession of a first user device 104, a second user 106 in possession of a second user device 108, and a third user 110 in possession of a third user device 112. The environment 100 further includes a merchant server 114, a payment network server 116, and a first issuer server 118. The first, second, and third user devices 104, 108, and 112, the merchant server 114, the payment network server 116, and the first issuer server 118 may communicate with each other by way of a communication network 120 or through separate communication networks established therebetween.

The first user 102 is an individual, who is an account holder of a first user account. The first user account may be a first payment account maintained at a financial institution, such as a first issuer, or a first digital wallet maintained at the first issuer. Examples of the first digital wallet include, but are not limited to, Apple Pay Cash®, or the like. The first user 102 is a cardholder of a first transaction card (not shown) issued by the first issuer. The first transaction card may be linked to the first payment account. The first user 102 is in possession of a first voucher (such as a gift voucher or a discount voucher). It will be apparent to those of skill in the art that the first voucher may be issued by entities such as financial institutions (such as the payment network server 116 or the first issuer server 118), merchants (such as a first merchant associated with the merchant server 114 or a second merchant that is different from the first merchant), or the like. In a non-limiting example, it is assumed that the first voucher is issued to the first user 102 by the first merchant.

The first user device 104 is a communication device of the first user 102. Examples of the first user device 104 may include a smartphone, a personal computer, a tablet, a phablet, or the like. The first user device 104 is used by the first user 102 to access service applications, for example a first service application 122 or a second service application 124, for redeeming vouchers (for example, the first voucher) and purchasing products and/or services, respectively. The first service application 122 may be a payment application that offers a voucher redemption service (VRS) to the first user 102. The second service application 124 may be an e-commerce application that allows the first user 102 to purchase products and/or services from the first merchant. The first user 102 may access the second service application 124 to purchase the products and/or services from the first merchant and the first service application 122 to redeem the first voucher against the purchase. In one embodiment, the first service application 122 may further allow the first user 102 to purchase various products and/or services. The first service application 122 and the second service application 124 may be mobile applications or web applications that run on the first user device 104.

The second user 106 is an individual, who is an account holder of a second user account. The second user account may be a second payment account or a second digital wallet. In a non-limiting example, it is assumed that the second user account is maintained at the first issuer. It will be apparent to those of skill in the art that the second user account may be maintained at an issuer other than the first issuer.

The second user device 108 is a communication device of the second user 106. It will be apparent to those of skill in the art that the second user device 108 is functionally similar to the first user device 104. The second user 106 may access the first and second service applications 122 and 124 that run on the second user device 108. Examples of the second user device 108 may include a smartphone, a personal computer, a tablet, a phablet, or the like.

Similarly, the third user 110 is an individual, who is an account holder of a third user account. The third user account may be a third payment account or a third digital wallet. In a non-limiting example, it is assumed that the third user account is maintained at the first issuer. It will be apparent to those of skill in the art that the third user account may be maintained at an issuer other than the first issuer.

The third user device 112 is a communication device of the third user 110. It will be understood by those of skill in the art that the third user device 112 is functionally similar to the second user device 108. The third user 110 may access the first and second service applications 122 and 124 that run on the third user device 112. Examples of the third user device 112 may include a smartphone, a personal computer, a tablet, a phablet, or the like.

The merchant server 114 is a computing server operated by the first merchant. The merchant server 114 hosts the second service application 124. The second service application 124 may present, to users (such as the first, second, and third users 102, 106, and 110) on corresponding user devices (such as the first, second, and third user devices 104, 108, and 112), a catalogue of products and/or services offered for sale by the first merchant. The second service application 124 may allow the users to purchase the products and/or services offered by the first merchant. The first merchant may also issue vouchers (such as gift vouchers and/or discount vouchers) to users (such as the first user 102) by way of the second service application 124 or any other method known in the art. The issued vouchers may be redeemable on purchases made by the users from the first merchant. The issued vouchers may be physical vouchers or digital vouchers. Each voucher may be associated with a voucher identifier, a voucher value, an expiry date, a purchase category, or the like. For example, the first voucher issued by the merchant server 114 to the first user 102 may be associated with a first voucher identifier, a first voucher value, a first expiry date, a purchase category, or the like.

In a scenario where the first voucher is a discount voucher, the first voucher value is a minimum purchase amount associated with the discount voucher. This implies that the first voucher may be redeemed against a purchase having a purchase amount greater than or equal to the minimum purchase amount. For example, the discount voucher may offer a discount of ‘$100’ on a minimum purchase of ‘$500’ (i.e., the minimum purchase amount). In another scenario where the first voucher is a gift voucher, the first voucher value is a gift amount of the first voucher. In such a scenario, the first voucher may be used to completely or partly pay for a purchase based on the first voucher value and a purchase amount of the purchase.

The payment network server 116 is a computing server that is operated by a payment network. The payment network is an intermediate entity between acquirers (for example, an acquirer associated with the first merchant) and issuers for processing transactions and facilitating voucher redemption. In one embodiment, the payment network server 116 executes operations for providing the VRS by way of the first service application 122. The VRS allows the users (for example, the first user 102) to redeem vouchers (such as the first voucher).

The first issuer server 118 is a computing server that is operated by the first issuer. The first issuer may be a financial institution that manages user accounts (such as the first, second, and third payment accounts and/or the first, second, and third digital wallets) of multiple users (such as the first, second, and third users 102, 106, and 110). Account details of the user accounts established with the first issuer are stored as account profiles. The first issuer server 118 credits and debits the user accounts (such as the first, second, and third user accounts) based on purchases made by the users (such as the first user 102) from the corresponding user accounts.

The communication network 120 is a medium through which content and messages are transmitted between the first through third user devices 104, 108, and 112, the merchant server 114, the payment network server 116, the first issuer server 118, and other entities that are pursuant to one or more standards for the interchange of transaction messages, such as the ISO8583 standard. Examples of the communication network 120 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 120 in accordance with various wired and wireless communication protocols, such as Transmission Control Protocol and Internet Protocol (TCP/IP), User Datagram Protocol (UDP), Long Term Evolution (LTE) communication protocols, or any combination thereof.

The first service application 122 is executable on various user devices (such as the first, second, and third user devices 104, 108, and 112) and enables corresponding users (such as the first, second, and third users 102, 106, and 110) to avail the VRS. In one embodiment, the first service application 122 is hosted by the payment network server 116. The first user 102 may avail the VRS by way of the first service application 122 that runs on the first user device 104. The VRS offered by the first service application 122 may enable the first user 102 to redeem a discount voucher against a purchase even if a purchase amount of the purchase is less than a minimum purchase amount associated with the discount voucher. Further, the VRS may enable the first user 102 to encash a gift voucher.

The second service application 124 is executable on various user devices (such as the first, second, and third user devices 104, 108, and 112) and enables corresponding users (such as the first, second, and third users 102, 106, and 110) to purchase the products and/or services offered for sale by the first merchant. In one embodiment, the second service application 124 is hosted by the merchant server 114.

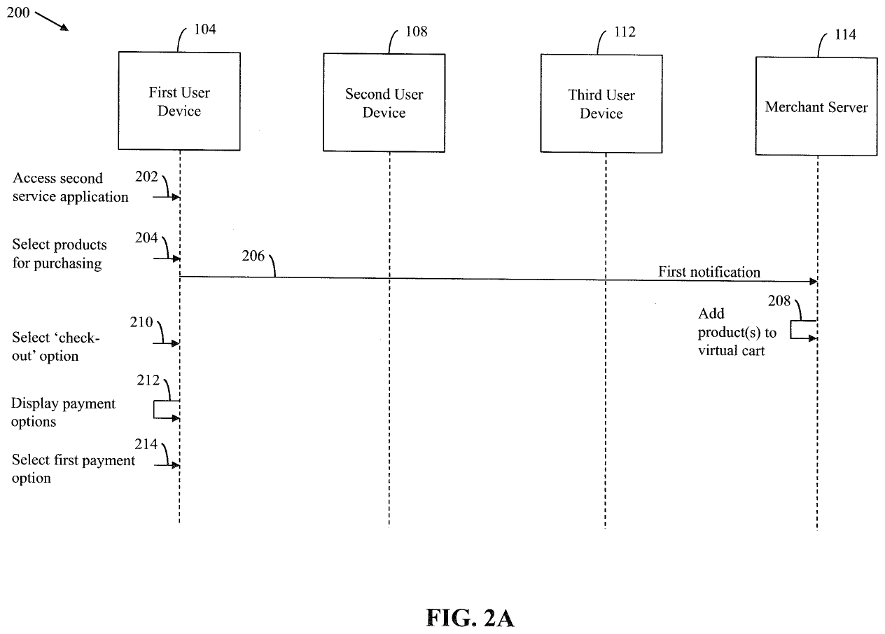

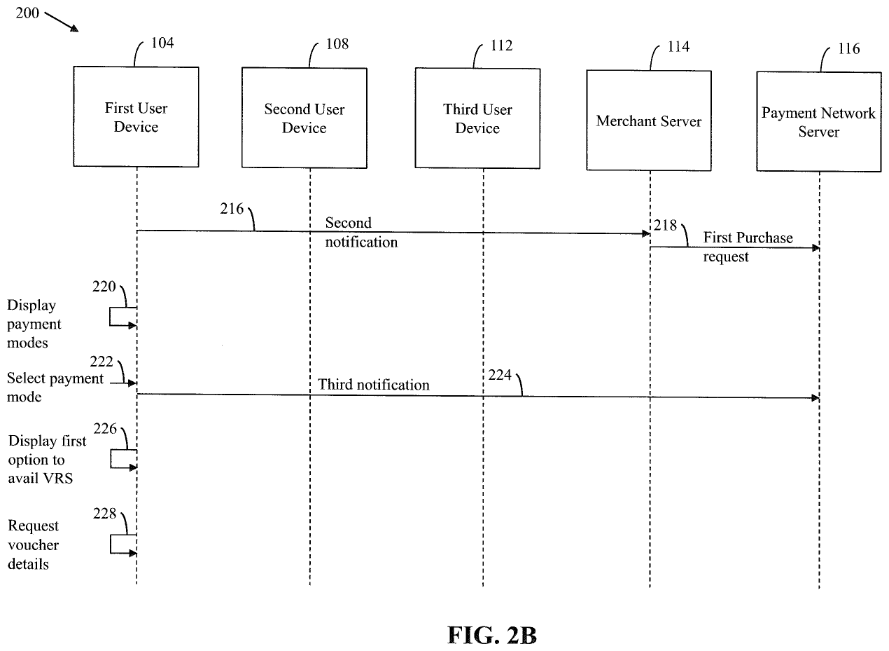

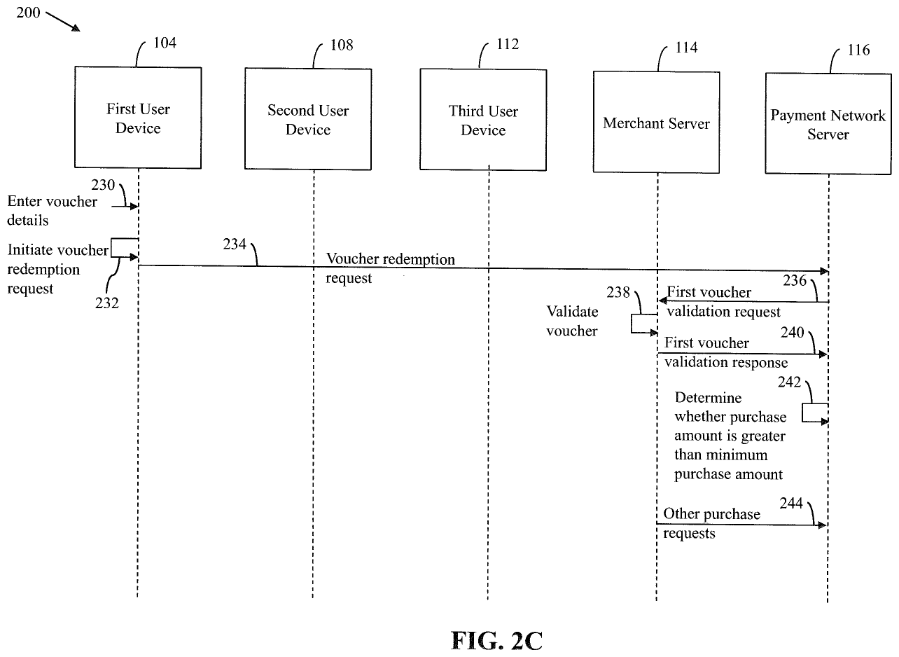

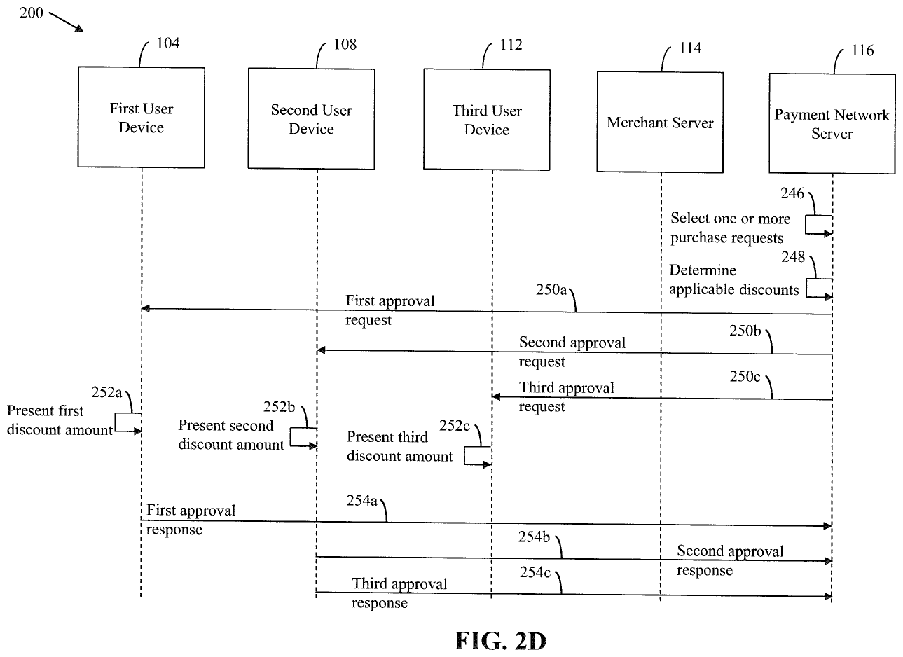

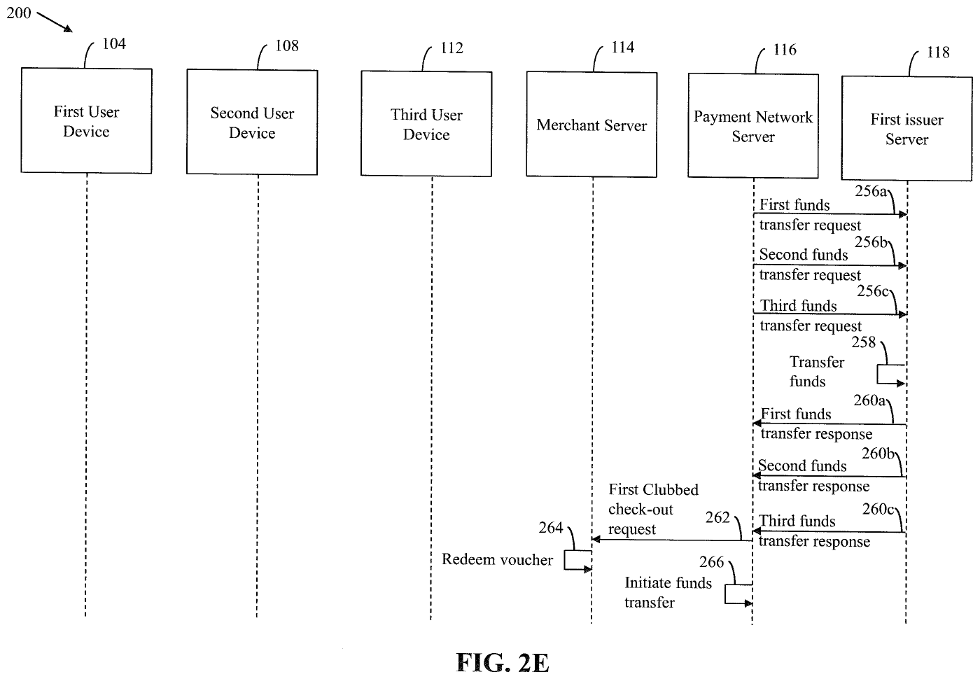

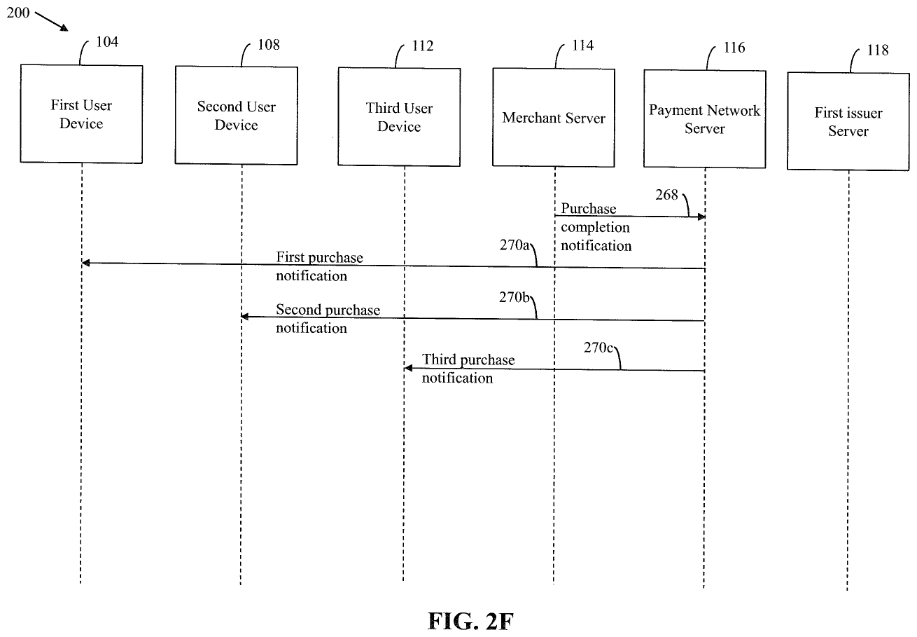

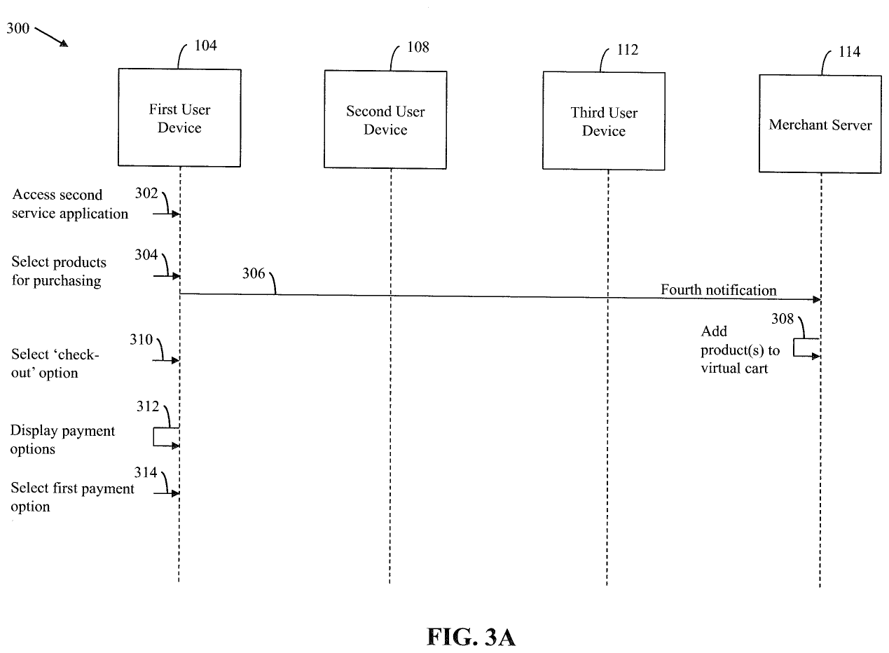

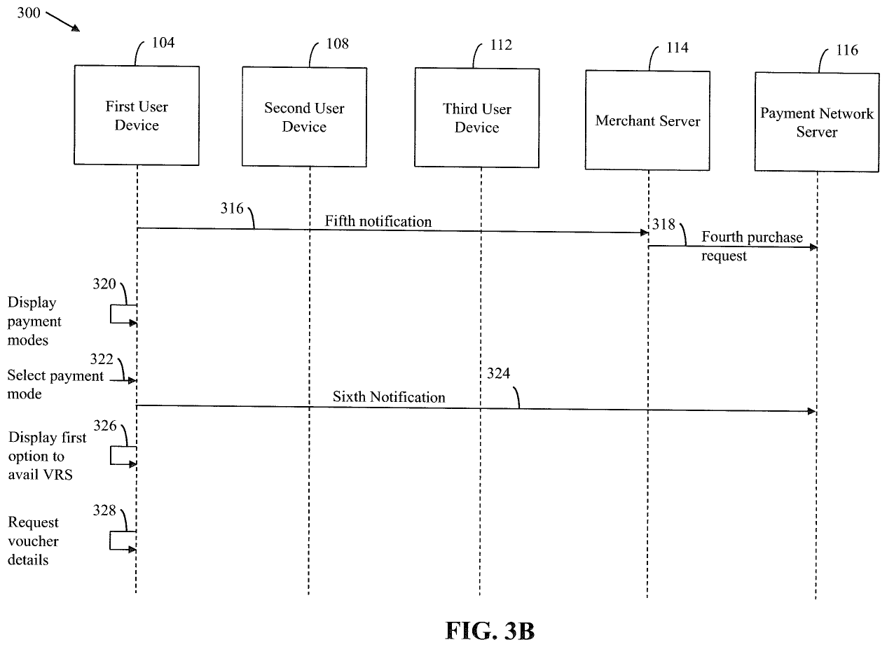

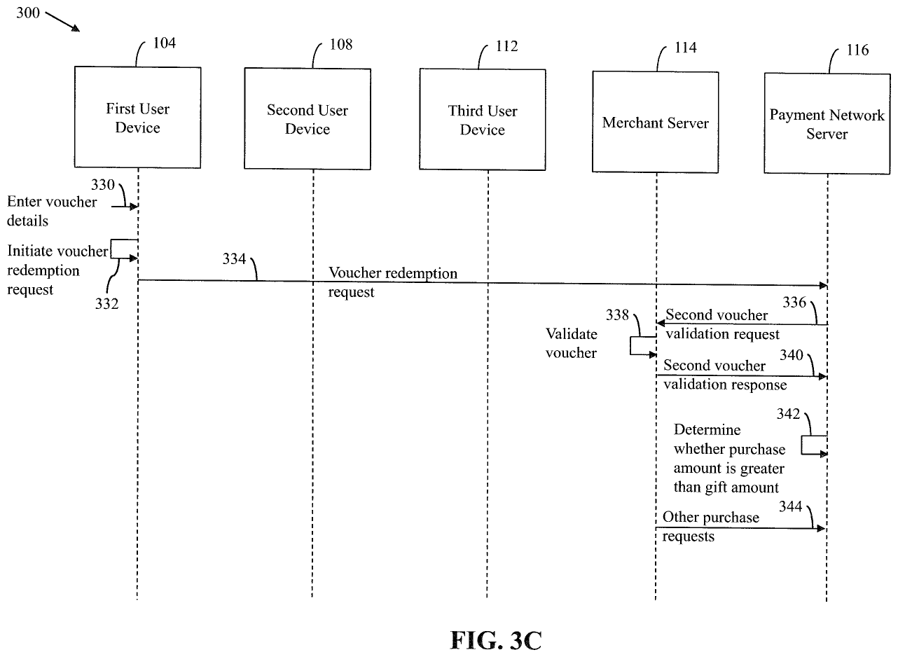

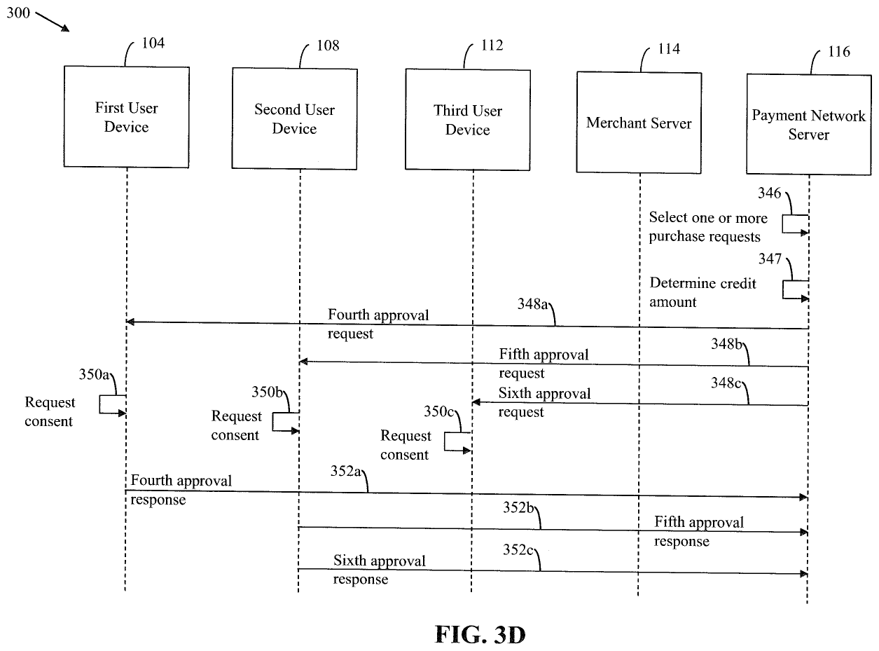

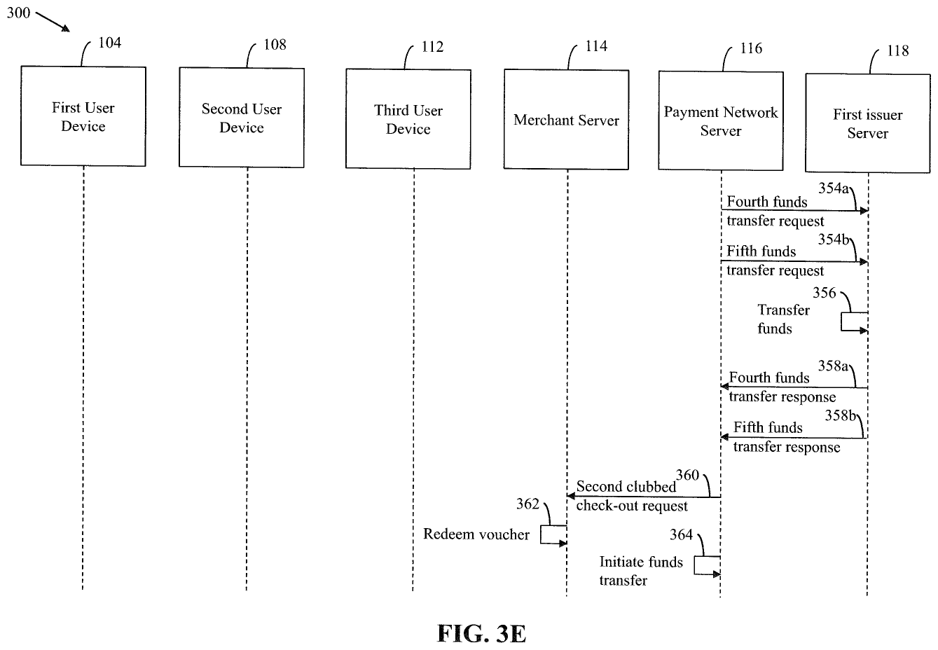

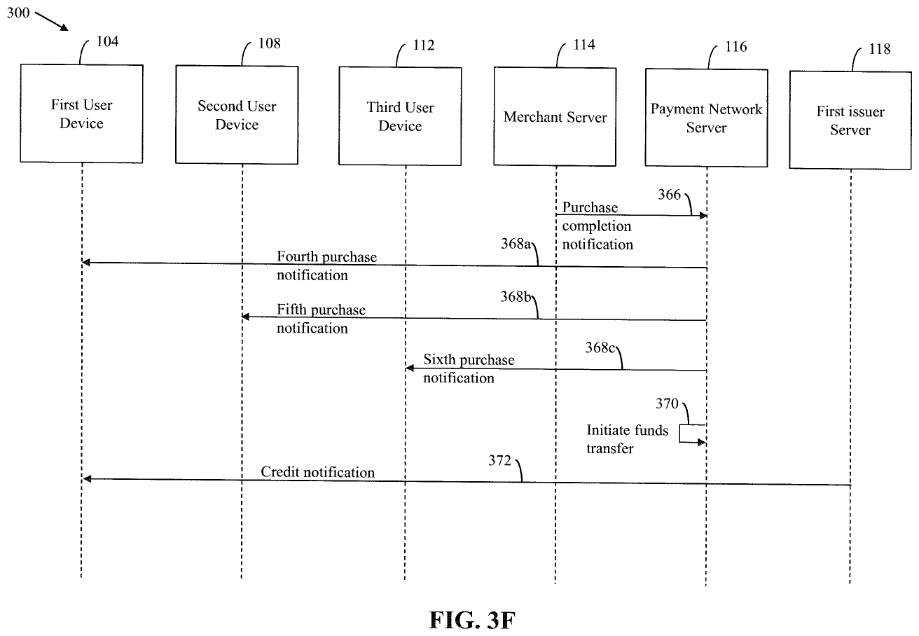

In operation, the first user 102 accesses the second service application 124 that runs on the first user device 104 to initiate a first purchase request for making a first purchase from the first merchant. The first user 102 may opt to pay for the first purchase by using the first service application 122. Consequently, the merchant server 114 communicates a first purchase request that includes purchase details (such as a purchase amount, a purchase category of the first purchase, or the like) of the first purchase to the payment network server 116. The payment network server 116 may request, by way of the first service application 122, the first user 102 to provide voucher details of a voucher that the first user 102 wants to redeem against the first purchase. The first user 102 may provide the voucher details of the first voucher to the first service application 122. Based on the voucher details provided by the first user 102, the first user device 104 communicates a voucher redemption request to the payment network server 116 for redeeming the first voucher. The voucher redemption request includes the voucher details, such as the first voucher identifier, the first voucher value, the purchase category of the first voucher, the first expiry date, or the like. In one embodiment, the first voucher is a discount voucher. In another embodiment, the first voucher is a gift voucher. The payment network server 116 receives the voucher redemption request from the first user device 104. The payment network server 116 validates the first voucher based on the voucher details included in the voucher redemption request. Based on the validation of the first voucher, the payment network server 116 facilitates the redemption of the first voucher. Operations performed by the payment network server 116 for redeeming the first voucher are explained in details in conjunction with FIGS. 2A-2F and 3A-3F.

In another embodiment, functionalities offered by the first service application 122 may also be offered by the second service application 124 hosted by the merchant server 114. It will be apparent to those of skill in the art that the first service application 122 and the second service application 124 may be integrated into a single application that allows users to access functionalities offered by both the first service application 122 and the second service application 124. This single application may be hosted by the merchant server 114 or any other entity (such as the payment network server 116, the first issuer server 118, or the like). In another embodiment, the first service application 122 is hosted by the merchant server 114.

FIGS. 2A-2F, collectively represent a process flow diagram 200 that illustrates an exemplary scenario for redeeming a discount voucher, in accordance with an embodiment of the present invention. For the sake of ongoing description of FIGS. 2A-2F, it is assumed that the first user 102 uses the second service application 124 that runs on the first user device 104 for purchasing a first product and the first service application 122 for availing the VRS. The process flow diagram 200 involves the first, second, and third user devices 104, 108, and 112, the merchant server 114, the payment network server 116, and the first issuer server 118. For the sake of ongoing description of FIGS. 2A-2F, the first voucher is assumed to be and referred to as the discount voucher.

The first user 102 accesses the second service application 124 that runs on the first user device 104 (as shown by arrow 202). The second service application 124 renders a first user interface (UI) on a display of the first user device 104. The first UI displays the catalogue of products and/or services offered for sale by the first merchant. The first user 102 selects, from the catalogue, the first product (for example, a first mobile phone) for purchasing (as shown by arrow 204). In other words, a first purchase by the first user 102 is a purchase of the first product. The first user device 104 communicates a first notification to the merchant server 114, indicating the selection of the first product (as shown by arrow 206). Based on the first notification, the merchant server 114 adds the first product to a first virtual cart of the first user 102 (as shown by arrow 208). The first virtual cart is maintained by the merchant server 114. The first virtual cart stores a list of products and/or services selected by the first user 102 for purchase.

The first user 102 selects a ‘check-out’ option displayed on the first UI for purchasing the first product (as shown by arrow 210). Based on the selection of the ‘check-out’ option, the second service application 124 displays various payment options for the first purchase (as shown by arrow 212). The displayed payment options may include a first payment option that allows the first user 102 to pay for the first purchase by using the first service application 122. It will be apparent to a person of skill in the art that the displayed payment options may also include other options that allow the first user 102 to pay for the first purchase by using transaction cards, netbanking, digital wallets, or the like.

The first user 102 selects the first payment option to pay for the first purchase (as shown by arrow 214). Based on the selection of the first payment option, control is redirected from the second service application 124 to the first service application 122 and a second UI of the first service application 122 is rendered on the display of the first user device 104. The first user device 104 communicates a second notification to the merchant server 114 indicating the selection of the first payment option (as shown by arrow 216). Based on the second notification, the merchant server 114 generates and communicates a first purchase request to the payment network server 116 (as shown by arrow 218). The first purchase request may include purchase details such as a first purchase amount of the first purchase, a purchase category (for example, ‘Electronics’) of the first purchase, a first merchant identifier of the first merchant, a first transaction reference number of the first purchase, and/or the like. In one embodiment, the first purchase request is pursuant to one or more standards for the interchange of transaction messages, such as the ISO8583 standard. The purchase details may be included as a data element (e.g., data element, DE, 126) in the first purchase request. In other words, the DE 126 may allow the merchant server 114 to specify the purchase details of the first purchase in the first purchase request.

Based on the first purchase request, the payment network server 116 displays a list of payment modes on the second UI and prompts the first user 102 to select a payment mode from the list of payment modes to pay for the first purchase (as shown by arrow 220). The list of payment modes includes various payment modes (e.g., the first digital wallet, the first payment account, or the first transaction card) that have been registered (i.e., saved) by the first user 102 with the payment network server 116. The second UI may, further, allow the first user 102 to add or register a new payment mode other than the displayed payment modes. The first user 102 selects a payment mode from the displayed payment modes (as shown by arrow 222). In a non-limiting example, it is assumed that the first user 102 selects the first transaction card to pay for the first purchase. The first user device 104 communicates a third notification to the payment network server 116 to indicate that the first user 102 has selected the first transaction card to pay for the first purchase (as shown by arrow 224).

The second UI, further, displays a first option to allow the first user 102 to avail the VRS (as shown by arrow 226). In a non-limiting example, it is assumed that the first user 102 selects the first option (i.e., the first user 102 opts to avail the VRS). Based on the selection of the first option, the second UI prompts the first user 102 to enter voucher details of a voucher that the first user 102 wants to redeem (as shown by arrow 228). The first user 102 provides the voucher details of the discount voucher to the first service application 122 (as shown by arrow 230). The voucher details of the discount voucher may include a first voucher identifier. The first voucher identifier may be an alphanumeric code that uniquely identifies the discount voucher. The voucher details of the discount voucher may, further, include a first expiry date, a minimum purchase amount, a discount amount, or the like. The discount amount of the discount voucher indicates a discount that may be availed by redeeming the discount voucher. The minimum purchase amount defines a constraint for redeeming the discount voucher. For example, the minimum purchase amount may be equal to ‘$2,000’ and the discount amount may be equal to ‘$500’. This implies that the discount voucher is redeemable for a discount of ‘$500’ on a purchase worth ‘$2,000’ or more. In a non-limiting example, it is assumed that the first purchase amount (e.g. ‘$500’) of the first purchase is less than the minimum purchase amount (i.e., ‘$2,000’). Based on the voucher details provided by the first user 102, the first service application 122 initiates a voucher redemption request (as shown by arrow 232). The voucher redemption request includes the voucher details provided by the first user 102.

The first user device 104 communicates the voucher redemption request to the payment network server 116 (as shown by arrow 234). Based on the voucher redemption request, the payment network server 116 communicates a first voucher validation request to the merchant server 114, requesting the merchant server 114 to validate the discount voucher (as shown by arrow 236). The first voucher validation request includes the voucher details of the discount voucher. The merchant server 114 validates the discount voucher based on the first voucher validation request (as shown by arrow 238). In other words, the merchant server 114 verifies an authenticity of the discount voucher. The merchant server 114 communicates a first voucher validation response to the payment network server 116 (as shown by arrow 240). The first voucher validation response indicates whether the discount voucher is valid. If the first voucher validation response indicates that the discount voucher is invalid, the payment network server 116 may communicate a message, indicating a voucher validation failure, to the first user device 104 and may request the first user 102 to re-enter the voucher details. In a non-limiting example, it is assumed that the first voucher validation response indicates that the discount voucher is valid.

Based on the first voucher validation response, the payment network server 116 determines whether the first purchase amount is greater than or equal to the minimum purchase amount associated with the discount voucher (as shown by arrow 242). The payment network server 116 may further receive a set of purchase requests corresponding to purchases made by other users (for example, the second and third users 106 and 110) from the merchant server 114 (as shown by arrow 244). The other users may have chosen the first service application 122 as a payment option to pay for the corresponding purchases. Each purchase request in the set of purchase requests is similar to the first purchase request and is indicative of a purchase amount, a purchase category, and/or a transaction reference number associated with the corresponding purchase.

When the payment network server 116 determines that the first purchase amount (i.e., ‘$500’) is less than the minimum purchase amount (i.e., ‘$2,000’) of the discount voucher, the payment network server 116 selects purchase requests (hereinafter, referred to as “selected purchase requests”) from the set of purchase requests (as shown by arrow 246). The payment network server 116 selects the purchase requests such that a sum of purchase amounts of the selected purchase requests and the first purchase amount is greater than or equal to the minimum purchase amount. In other words, the payment network server 116 may club the first purchase request with the selected purchase requests so that a cumulative purchase amount of the first purchase and the purchases corresponding to the selected purchase requests exceeds or becomes equal to the minimum purchase amount of the discount voucher.

In one embodiment, the payment network server 116 may select those purchase requests from the set of purchase requests that are associated with the same purchase category as the first purchase request. For example, if the purchase category of the first purchase request is “Electronics”, the payment network server 116 selects the purchase requests having the purchase category as “Electronics”. In another embodiment, the payment network server 116 may select the purchase requests from the set of purchase requests irrespective of the purchase category of the first purchase request. In one exemplary scenario, the purchase requests in the set of purchase requests may be associated with more than one purchase category. In such a scenario, the payment network server 116 may select those purchase requests from the set of purchase requests that have at least one product having the purchase category as ‘electronics’, and a sum of the first purchase amount and purchase amounts corresponding to products having the purchase category as ‘electronics’ in the selected purchase requests is greater than or equal to the minimum purchase amount of the discount voucher. In other words, the payment network server 116 may take into consideration the purchase amounts of the products that belong to the purchase category ‘electronics’ in the selected purchase requests. In a non-limiting example, it is assumed that the payment network server 116 selects second and third purchase requests corresponding to second and third purchases made by the second and third users 106 and 110, respectively. In one example, second and third purchase amounts corresponding to the second and third purchase requests, respectively, are equal to ‘$750’. Thus, a sum of the first, second, and third purchase amounts is equal to ‘$2,000’ (i.e., $500+$750+$750=$2,000). It will be apparent to those of skill in the art that the selected purchase requests may include any number of purchase requests.

After the selection of the second and third purchase requests, the payment network server 116 clubs the first through third purchase requests and determines first, second, and third discount amounts applicable on the first, second and third purchases, respectively (as shown by arrow 248). In other words, the first, second and third purchases are clubbed. By clubbing the first purchase with the selected purchases (i.e., the second and third purchases), the payment network server 116 may be able to redeem the discount voucher against the clubbed purchases, thereby allowing the first user 102 and the other users (e.g., the second and third users 106 and 110) to avail partial discounts on the corresponding purchases. In one embodiment, the payment network server 116 may charge a service fee for offering the VRS. In a non-limiting example, the service fee charged by the payment network server 116 is fixed and equal to ‘$20’. The payment network server 116 may determine the first, second, and third discount amounts and the service fee based on the discount amount (i.e., ‘$500’), a count (here, three) of purchase requests against which the discount voucher is to be redeemed, a purchase amount (such as the first, second, and third purchase amounts) associated with each purchase request, or the like. In one embodiment, the first, second, and third discount amounts are proportional and are based on a ratio of the first, second, and third purchase amounts. Thus, the first, second, and third discount amounts are ‘$120’, ‘$180’, and ‘$180’, respectively. A sum of the service fee and the first, second, and third discount amounts is equal to the discount amount (i.e., $20+$120+$180+$180=$500) of the discount voucher. In another embodiment, the first discount amount may be higher than the second and third discount amounts, as the discount voucher belongs to the first user 102.

Based on the determination of the first, second, and third discount amounts and the service fee, the payment network server 116 communicates first, second, and third approval requests to the first, second, and third user devices 104, 108, and 112, respectively (as shown by arrows 250a-250c, respectively). The first, second, and third approval requests are indicative of the first, second and third discount amounts, respectively. The first, second, and third approval requests are for obtaining consents from the first, second, and third users 102, 106, and 110 on the first, second, and third purchases and for redeeming the discount voucher against the first, second, and third purchases, respectively. Based on the second and third approval requests, the first service application 122 that runs on the second and third user devices 108 and 112 renders the second UI on displays of the second and third user devices 108 and 112, respectively.

The second UI rendered on the displays of the first, second, and third user devices 104, 108, and 112, presents the first, second, and third discount amounts (i.e., ‘$120’, ‘$180’, and ‘$180’, respectively) that are applicable on the first, second and third purchases (as shown by arrows 252a-252c, respectively). The second UI rendered on the displays of the first, second, and third user devices 104, 108, and 112, further, presents first through third payable amounts that are to be paid by the first, second, and third users 102, 106, and 110 for the first through third purchases, respectively. For example, the first payable amount for the first purchase after charging the service fee and applying the first discount amount is ‘$380’ (i.e., $500−$120=$380). In other words, the first payable amount for the first purchase is determined by deducting the first discount amount from a sum of the first purchase amount and the service fee. The second payable amount for the second purchase after applying the second discount amount is ‘$570’ (i.e., $750−$180=$570) and the third payable amount for the third purchase after applying the third discount amount is ‘$570’ (i.e., $750−$180=$570). In other words, the second payable amount for the second purchase is determined by deducting the second discount amount from a sum of the second purchase amount and the service fee, and the third payable amount for the third purchase is determined by deducting the third discount amount from a sum of the third purchase amount and the service fee. The second UI further prompts the first, second, and third users 102, 106, and 110 to provide consents for redeeming the discount voucher against the first, second, and third purchase requests. In a non-limiting example, it is assumed that the first, second, and third users 102, 106, and 110 provide consents for redeeming the discount voucher against the first, second, and third purchase requests.

Based on the consents provided by the first through third users 102, 106, and 110, the first through third user devices 104, 108, and 112 communicate first through third approval responses, respectively, to the payment network server 116 (as shown by arrows 254a-254c). Based on the first through third approval responses, the payment network server 116 communicates first through third funds transfer requests to the first issuer server 118 (as shown by arrows 256a-256c). The first funds transfer request includes details pertaining to the first payable amount, the first transaction card details, an identifier (such as an account number) of a fourth payment account of the payment network, or the like. The first funds transfer request is for transferring the first payable amount from the first payment account linked to the first transaction card to the fourth payment account of the payment network (i.e., the recipient account). The fourth payment account may be maintained at a second issuer or the first issuer. Similarly, the second funds transfer request includes details pertaining to the second payable amount, wallet details of the second digital wallet, the identifier of the fourth payment account, or the like. The second funds transfer request is for transferring the second payable amount from the second digital wallet to the fourth payment account. Similarly, the third funds transfer request includes details pertaining to the third payable amount, wallet details of the third digital wallet, the identifier of the fourth payment account, or the like. Similarly, the third funds transfer request is for transferring the third payable amount from the third digital wallet to the fourth payment account. The first issuer server 118 transfers the first through third payable amounts to the fourth payment account based on the first through third funds transfer requests (as shown by arrow 258). The first issuer server 118 communicates first, second, and third funds transfer responses to the payment network server 116 (as shown by arrows 260a-260c, respectively). The first funds transfer response indicates that the first payable amount is transferred to the fourth payment account. Similarly, the second funds transfer response indicates that the second payable amount is transferred to the fourth payment account and the third funds transfer response indicates that the third payable amount is transferred to the fourth payment account. Thus, the fourth payment account is credited with the first through third payable amounts (i.e., $380+$570+$570=$1,520).

The payment network server 116 clubs the first through third purchases and performs a clubbed check-out to pay the first merchant on behalf of the first through third users 102, 106, and 110. For performing the clubbed check-out, the payment network server 116 generates and communicates a first clubbed check-out request to the merchant server 114 for initiating a redemption of the discount voucher (as shown by arrow 262). The first clubbed check-out request may include transaction reference numbers (such as the first transaction reference number) of the first, second, and third purchases and the voucher details of the discount voucher. Based on the first clubbed check-out request, the discount voucher is redeemed by the merchant server 114 against the first, second, and third purchases (as shown by arrow 264), as the sum of the first, second, and third purchase amounts is equal to ‘$2,000’ (i.e., equal to the minimum purchase amount). Based on the redemption of the discount voucher, the payment network server 116 is required to pay ‘$1,500’ (i.e., $2,000−$500=$1,500) to the first merchant for the first, second, and third purchases. The payment network server 116 initiates a funds transfer for transferring ‘$1,500’ from the fourth payment account to a merchant account of the first merchant (as shown by arrow 266). The merchant account may be maintained at a financial institution, such as an acquirer (not shown). In a non-limiting example, it is assumed that the acquirer is the first issuer. Thus, the merchant account is maintained at the first issuer server 118. After paying ‘$1,500’ to the first merchant, the payment network server 116 has ‘$20’ (i.e., $1,520−$1,500=$20, the service fee) remaining in the fourth payment account and makes a profit of ‘$20’ (i.e., the service fee) by offering the VRS. When the merchant server 114 receives ‘$1,500’ in the merchant account, the merchant server 114 communicates a purchase completion notification to the payment network server 116, apprising the payment network of a completion of the first, second, and third purchases (as shown by arrow 268). Based on the purchase completion notification, the payment network server 116 transmits first through third purchase notifications to the first, second, and third user devices 104, 108, and 112, respectively (as shown by arrows 270a-270c). The first, second, and third purchase notifications indicate successful completion of the first through third purchases, respectively, and the redemption of the discount voucher.

In another embodiment, if any of the second and third users 106 and 110 does not provide consent for redeeming the voucher, the payment network server 116 may, again, select purchase requests from the set of purchase requests, such that a sum of the first purchase amount and purchase amounts corresponding to the selected purchase requests equals or exceeds the minimum purchase amount for redeeming the discount voucher.

In another embodiment the functions performed by the first service application 122 and the payment network server 116 may be performed by the second service application 124 and the merchant server 114, respectively. In such a scenario, the merchant server 114 may select the purchase requests to club with the first purchase request for redeeming the discount voucher.

FIGS. 3A-3F, collectively represent a process flow diagram 300 that illustrates an exemplary scenario for redeeming a gift voucher, in accordance with another embodiment of the present invention. For the sake of ongoing description of FIGS. 3A-3F, it is assumed that the first user 102 uses the second service application 124 that runs on the first user device 104 for purchasing a second product and the first service application 122 for availing the VRS. The process flow diagram 300 involves the first, second, and third user devices 104, 108, and 112, the merchant server 114, the payment network server 116, and the first issuer server 118. For the sake of ongoing description of FIGS. 3A-3F, the first voucher is assumed to be and referred to as the gift voucher.

The first user 102 accesses the second service application 124 that runs on the first user device 104 (as shown by arrow 302). The second service application 124 renders the first UI on the display of the first user device 104. The first user 102 selects, from the catalogue, the second product (for example, a second mobile phone) for purchasing (as shown by arrow 304). The first user device 104 communicates a fourth notification to the merchant server 114, indicating the selection of the second product (as shown by arrow 306). Based on the fourth notification, the merchant server 114 adds the second product to the first virtual cart of the first user 102 (as shown by arrow 308). The first user 102 selects the ‘check-out’ option displayed on the first UI for purchasing the second product (as shown by arrow 310). Based on the selection of the ‘check-out’ option, the second service application 124 displays various payment options for making a fourth purchase (as shown by arrow 312). The fourth purchase corresponds to the purchase of the second product by the first user 102.

The first user 102 selects the first payment option (i.e., the first service application 122) to pay for the fourth purchase (as shown by arrow 314). Based on the selection of the first payment option, control is redirected from the second service application 124 to the first service application 122 and the second UI of the first service application 122 is rendered on the display of the first user device 104. The first user device 104 communicates a fifth notification to the merchant server 114, indicating the selection of the first payment option (as shown by arrow 316). Based on the fifth notification, the merchant server 114 generates and communicates a fourth purchase request to the payment network server 116 (as shown by arrow 318). The fourth purchase request may indicate a fourth purchase amount of the fourth purchase, a purchase category (i.e., ‘Electronics’) of the fourth purchase, the first merchant identifier of the first merchant, a transaction reference number of the fourth purchase, and/or the like. The fourth purchase request is pursuant to one or more standards for the interchange of transaction messages, such as the ISO8583 standard.

Based on the fourth purchase request, the payment network server 116 displays the list of payment modes on the second UI and prompts the first user 102 to select a payment mode from the list of payment modes to pay for the fourth purchase (as shown by arrow 320). The first user 102 selects a payment mode from the displayed payment modes (as shown by arrow 322). In a non-limiting example, it is assumed that the first user 102 selects the first transaction card to pay for the fourth purchase. The first user device 104 communicates a sixth notification to the payment network server 116 to indicate that the first user 102 has selected the first transaction card to pay for the fourth purchase (as shown by arrow 324). The second UI, further, displays the first option to allow the first user 102 to avail the VRS (as shown by arrow 326). In a non-limiting example, it is assumed that the first user 102 selects the first option (i.e., the first user 102 opts to avail the VRS).

Based on the selection of the first option, the second UI prompts the first user 102 to enter voucher details of a voucher that the first user 102 wants to redeem (as shown by arrow 328). The first user 102 provides the voucher details of the gift voucher to the first service application 122 (as shown by arrow 330). The voucher details of the gift voucher may include the first voucher identifier. The voucher details of the gift voucher may, further, include the first expiry date, a gift amount, or the like. The gift voucher may or may not be associated with a purchase category. The gift amount of the gift voucher indicates an amount for which the gift voucher may be redeemed against a purchase (e.g., the fourth purchase). When the first user 102 redeems the gift voucher against the fourth purchase, the first user 102 may purchase the second product for free if the fourth purchase amount is less than or equal to the gift amount. If the fourth purchase amount is greater than the gift amount, the first user 102 may be required pay only an amount equal to a difference between the fourth purchase amount and the gift amount. For example, the fourth purchase amount may be equal to ‘$500’ and the gift amount may be equal to ‘$100’. Based on the voucher details of the gift voucher provided by the first user 102, the first service application 122 initiates a voucher redemption request (as shown by arrow 332). The voucher redemption request includes the voucher details provided by the first user 102.

The first user device 104 communicates the voucher redemption request to the payment network server 116 (as shown by arrow 334). Based on the voucher redemption request, the payment network server 116 communicates a second voucher validation request to the merchant server 114, requesting the merchant server 114 to validate the gift voucher (as shown by arrow 336). The second voucher validation request includes the voucher details of the gift voucher. The merchant server 114 validates the gift voucher based on the second voucher validation request (as shown by arrow 338). The merchant server 114 communicates a second voucher validation response to the payment network server 116 (as shown by arrow 340). The second voucher validation response indicates whether the gift voucher is valid. If the second voucher validation response indicates that the gift voucher is invalid, the payment network server 116 may communicate a message, indicating a voucher validation failure, to the first user device 104 and may request the first user 102 to re-enter the voucher details. In a non-limiting example, it is assumed that the second voucher validation response indicates that the gift voucher is valid.

Based on the second voucher validation response, the payment network server 116 determines whether the fourth purchase amount is greater than or equal to the gift amount (as shown by arrow 342). In a non-limiting example, the gift voucher may be encashed only if the fourth purchase amount is less than the gift amount. The gift voucher may be encashed for an amount that is less than or equal to a difference between the gift amount and the fourth purchase amount. The payment network server 116 may further receive a set of purchase requests corresponding to purchases made by other users (for example, the second and third users 106 and 110) from the merchant server 114 (as shown by arrow 344). The other users may have chosen the first service application 122 as a payment option to pay for the corresponding purchases. Each purchase request in the set of purchase requests is similar to the fourth purchase request and is indicative of a purchase amount, a purchase category, and/or a transaction reference number associated with the corresponding purchase.

When the fourth purchase amount is determined to be less than the gift amount, the payment network server 116 selects, from the set of purchase requests, purchase requests, such that a sum of the fourth purchase amount and purchase amounts corresponding to the selected purchase requests is greater than or equal to the gift amount (as shown by arrow 346). In a non-limiting example, it is assumed that the gift voucher is not associated with any purchase category. Thus, the payment network server 116 may not take into consideration purchase categories of the set of purchases while selecting the purchase requests. In a non-limiting example, it is assumed that the payment network server 116 selects fifth and sixth purchase requests corresponding to fifth and sixth purchases made by the second and third users 106 and 110, respectively. The fifth and sixth purchases are associated with fifth and sixth purchase amounts, respectively. In a non-limiting example, it is assumed that the fifth and sixth purchase amounts are equal to ‘$300’ and ‘$250’, respectively. Thus, a sum of the fourth, fifth, and sixth purchase amounts is equal to ‘$650’ (i.e., $100+$300+$250=$650). It will be apparent to those of skill in the art that the selected purchase requests may include any number of purchase requests.

The payment network server 116 clubs the fourth through sixth purchases for redeeming the gift voucher and determines a credit amount (i.e., a part of the gift amount) that may be encashed by the first user 102 based on the redemption of the gift voucher (as shown by arrow 347). The payment network server 116 may charge a service fee for offering the VRS (i.e., for allowing the first user 102 to encash the gift voucher). In the current embodiment, it is assumed that the service fee is fixed and equal to ‘$20’. In a non-limiting example, the credit amount may be equal to a difference between the gift amount and a sum of the service fee and the fourth purchase amount. Therefore, the credit amount equals ‘$380’ ($500−$100−$20=$380). The payment network server 116 communicates fourth, fifth, and sixth approval requests to first, second, and third user devices 104, 108, and 112, respectively (as shown by arrows 348a-348c). The fourth, fifth, and sixth approval requests are for requesting the first, second, and third users 102, 106, and 110 to approve the fourth, fifth, and sixth purchases, respectively. The fourth approval request is indicative of the credit amount that may be encashed by the first user 102. The fifth and sixth approval requests are indicative of the fifth and sixth purchase amounts to be paid by the second and third users 106 and 110 for the fifth and sixth purchases, respectively. Based on the fifth and sixth approval requests, the first service application 122 that runs on the second and third user devices 108 and 112 renders the second UI on the displays of the second and third user devices 108 and 112, respectively.

The second UI rendered on the display of the first user device 104 presents the credit amount that may be credited to a user account (such as the first payment account) of the first user 102. In other words, the second UI presents the credit amount that may be encashed by the first user 102. The first service application 122 prompts the first user 102 to provide consent for redeeming the gift voucher (as shown by arrow 350a). In other words, the first service application 122 prompts the first user 102 to accept the credit amount. The second UI, rendered on the displays of the second and third user devices 108 and 112, presents the fifth (‘$300’) and sixth (‘$250’) purchase amounts payable by the second and third users 106 and 110 for the fifth and sixth purchases, respectively. The second UI further prompts the second and third users 106 and 110 to provide consents for paying the fifth and sixth purchase amounts for the fifth and sixth purchases, respectively (as shown by arrows 350b-350c). In a non-limiting example, it is assumed that the first, second, and third users 102, 106, and 110 provide consents for the fourth, fifth, and sixth purchases, respectively. In one embodiment, the payment network server 116 may provide discounts to the second user 106 and the third user 110 on the fifth and sixth purchases, respectively, based on the redemption of the gift voucher. In such a scenario, the fifth and sixth approval requests include discount amounts and payable amounts for the fifth and sixth purchases, respectively.

Based on the consents provided by the first through third users 102, 106, and 110, the first through third user devices 104, 108, and 112 communicate fourth through sixth approval responses, respectively, to the payment network server 116 (as shown by arrows 352a-352c). Based on the fourth through sixth approval responses, the payment network server 116 communicates fourth and fifth funds transfer requests to the first issuer server 118 (as shown by arrows 354a and 354b). The fourth funds transfer request includes details pertaining to the fifth purchase amount, the wallet details of the second digital wallet, the identifier of the fourth payment account, or the like. The fourth funds transfer request is for transferring the fifth purchase amount from the second digital wallet to the fourth payment account. Similarly, the fifth funds transfer request includes details pertaining to the sixth purchase amount, the wallet details of the third digital wallet, the identifier of the fourth payment account, or the like. Similarly, the fifth funds transfer request is for transferring the sixth purchase amount from the third digital wallet to the fourth payment account. The first issuer server 118 transfers the fifth and sixth purchase amounts to the fourth payment account based on the fourth and fifth funds transfer requests (as shown by arrow 356). The first issuer server 118 communicates fourth and fifth funds transfer responses to the payment network server 116 (as shown by arrows 358a and 358b, respectively). The fourth funds transfer response indicates that the fifth purchase amount is transferred to the fourth payment account. Similarly, the fifth funds transfer response indicates that the sixth purchase amount is transferred to the fourth payment account. Thus, the fourth payment account is credited with the fifth and sixth purchase amounts (i.e., $300+$250=$550).

The payment network server 116 clubs the fourth through sixth purchases and performs a clubbed check-out to pay the first merchant on behalf of the first through third users 102, 106, and 110. For performing the clubbed check-out, the payment network server 116 generates and communicates a second clubbed check-out request to the merchant server 114 to initiate a redemption of the gift voucher (as shown by arrow 360). The second clubbed check-out request may include transaction reference numbers of the fourth, fifth, and sixth purchases and the voucher details of the gift voucher. Based on the second clubbed check-out request, the gift voucher is redeemed by the merchant server 114 against the fourth, fifth, and sixth purchase requests (as shown by arrow 362). Based on the redemption of the gift voucher, the payment network server 116 is required to pay ‘$150’ (i.e., 650−$500=$150) to the first merchant for the fourth, fifth, and sixth purchases. The payment network server 116 initiates a funds transfer for transferring ‘$150’ from the fourth payment account to the merchant account (as shown by arrow 364). Thus, the fourth payment account holds ‘$400’ after transferring ‘$150’ to the merchant account. When the merchant server 114 receives ‘$150’ in the merchant account, the merchant server 114 communicates a ‘purchase completion’ notification to the payment network server 116, apprising the payment network of a completion of the fourth, fifth, and sixth purchases (as shown by arrow 366).

Based on the ‘purchase completion’ notification, the payment network server 116 transmits fourth, fifth, and sixth purchase notifications to the first, second, and third user devices 104, 108, and 112, respectively (as shown by arrows 368a-368c). The fourth, fifth, and sixth purchase notifications indicate successful completion of the fourth, fifth, and sixth purchases, respectively. The payment network server 116 initiates, by way of the first issuer server 118, another funds transfer for transferring ‘$380’ (i.e., the credit amount) from the fourth payment account to the first payment account of the first user 102 (as shown by arrow 370). When ‘$380’ is received in the first payment account, the first issuer server 118 communicates a credit notification to the first user device 104, indicating that ‘$380’ is credited to the first payment account (as shown by arrow 372). The fourth payment account now holds ‘$20’ after transferring ‘$380’ to the first payment account. Thus, the payment network server 116 makes a profit of ‘$20’ (i.e., the service fee) by offering the VRS and the first user 102 is able to encash ‘$350’ by redeeming the gift voucher.

In another embodiment, the gift voucher may be associated with a purchase category. In one exemplary scenario, the second product may belong a purchase category different from a purchase category associated with the gift voucher. In such a scenario, the payment network server 116 may select, from the set of purchase requests, purchase requests associated with products that belong to the purchase category associated with the gift voucher, such that a sum of purchase amounts corresponding to the selected purchase requests equals or exceeds the gift amount of the gift voucher.

In another embodiment, the first user 102 may initiate a voucher redemption request for redeeming the gift voucher, without making a purchase from the first merchant. In other words, the first user 102 need not make a purchase for redeeming (i.e., encashing) the gift voucher. The payment network server 116 receives a voucher redemption request for redeeming the gift voucher. Based on the voucher redemption request, the payment network server 116 selects, from the set of purchase requests, purchase requests such that a sum of the purchase amounts corresponding to the selected purchase requests equals or exceeds the gift amount of the gift voucher. Therefore, the first user 102 may be able to encash the gift voucher for a credit amount equal to the gift amount or a difference between the gift amount and the service fee. In another embodiment, the payment network server 116 may initiate, by way of the first issuer server 118, another funds transfer for transferring a part of the gift amount from the fourth payment account to the second digital wallet of the second user 106 and another part of the gift amount from the fourth payment account to the third digital wallet of the third user 110, based on the redemption of the gift voucher.

Further, the payment network server 116 may advertise, by way of the first service application 122, discounts for various purchase categories based on voucher redemption requests received from users (such as the first user 102). This may encourage others users to customize corresponding virtual carts to avail maximum benefits from the discounts.

In another embodiment the functions performed by the first service application 122 and the payment network server 116 may be performed by the second service application 124 and the merchant server 114, respectively. In such a scenario, the merchant server 114 may select the purchase requests to club with the fourth purchase request for redeeming the gift voucher.

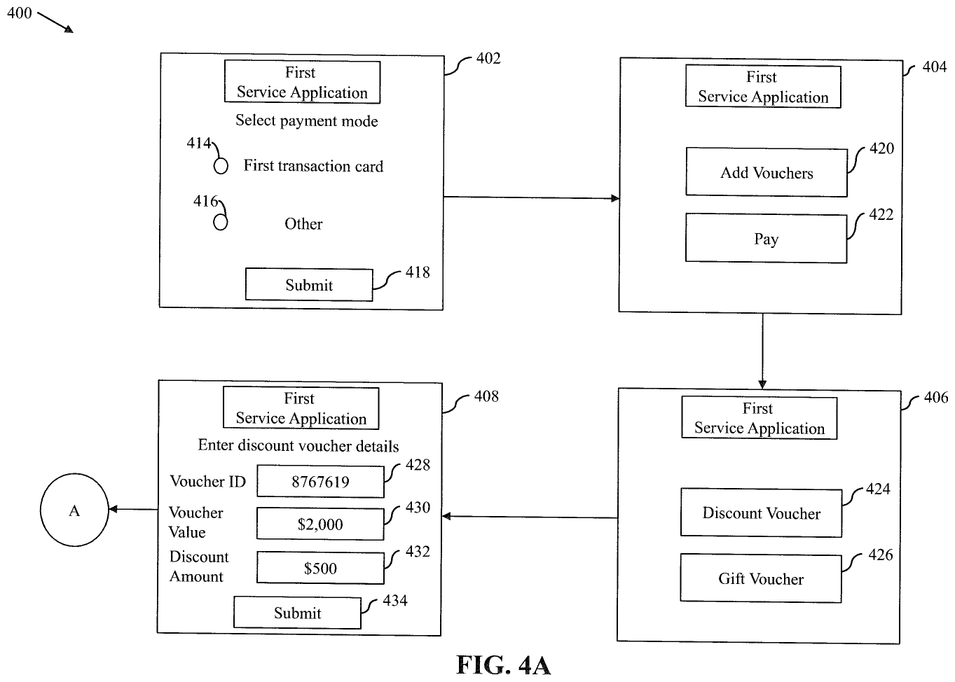

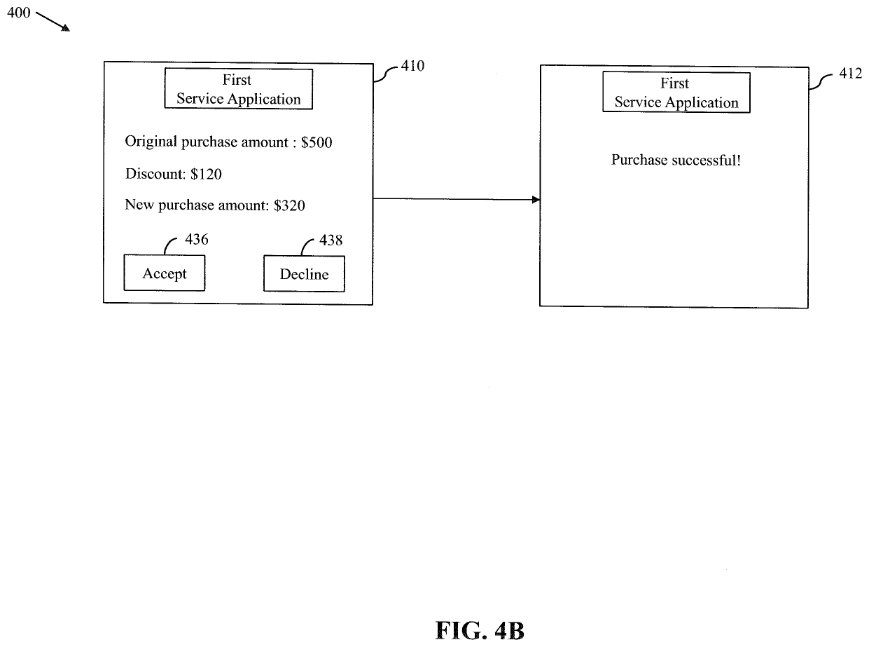

FIGS. 4A and 4B represent an exemplary scenario 400 that illustrates first through sixth UI screens 402, 404, 406, 408, 410, and 412 rendered by the first service application 122, in accordance with an embodiment of the present invention. The UI screens 402-412 are rendered on the display (not shown) of the first user device 104. FIGS. 4A and 4B have been explained in conjunction with FIGS. 2A-2F.

When the first user 102 selects the first payment option to pay for the first purchase (as described in the foregoing description of FIG. 2A), the first service application 122 renders the UI screen 402 on the display of the first user device 104. The UI screen 402 includes a first message prompting the first user 102 to select a payment mode for the first purchase. The UI screen 402 further includes first and second user-selectable options 414 and 416. The first user-selectable option 414 allows the first user 102 to select the first transaction card as the payment mode for the first purchase. In the current embodiment, it is assumed that the first user 102 has registered only the first transaction card as a payment mode with the payment network server 116. The second user-selectable option 416 allows the first user 102 to add or register a new payment mode. As described in the foregoing description of FIG. 2B, the first user 102 selects the first transaction card as the payment mode for the first purchase. The UI screen 402 further includes a first submit button 418. The first service application 122 serves as a gateway to the payment network server 116, and thus, when the first user 102 selects the first submit button 418, the selection of the first transaction card as the payment mode for the first purchase is communicated to the payment network server 116 as the third notification.

Based on the selection of the first transaction card as the payment mode, the first service application 122 renders the UI screen 404 on the display of the first user device 104. The UI screen 404 includes third and fourth user-selectable options 420 and 422. The third user-selectable option 420 allows the first user 102 to avail the VRS. In other words, the third user-selectable option 420 allows the first user 102 to apply a voucher against the first purchase. The fourth user-selectable option 422 allows the first user 102 to directly pay for the first purchase, without applying a voucher (i.e., without availing the VRS). As described in the foregoing description of FIG. 2B, the first user 102 selects the third user-selectable option 420. When the first user 102 selects the third user-selectable option 420, the first service application 122 renders the UI screen 406 on the display of the first user device 104. The UI screen 406 includes fifth and sixth user-selectable options 424 and 426. The fifth user-selectable option 424 allows the first user 102 to apply the discount voucher as described in the foregoing description of FIG. 2C. Similarly, the sixth user-selectable option 426 allows the first user 102 to apply the gift voucher as described in FIG. 3C. For the sake of ongoing description, it is assumed that the first user 102 selects the fifth user-selectable option 424.

Based on the selection of the fifth user-selectable option 424, the first service application 122 renders the UI screen 408 on the display of the first user device 104. The UI screen 408 includes a second message requesting the first user 102 to enter the voucher details of the discount voucher. The UI screen 408 includes first through third text boxes 428-432. The first through third text boxes 428-432 allow the first user 102 to provide the first voucher identifier, the minimum purchase amount (i.e., the voucher value of the discount voucher), and the discount amount (i.e., ‘$500’) of the discount voucher, respectively. It will be apparent to those of skill in the art that the UI screen 408 may also require the first user 102 to enter the first expiry date, the purchase category, or the like, of the discount voucher. In another embodiment, the UI screen 408 may require the first user 102 to enter only the first voucher identifier of the discount voucher. The first user 102 may provide the first voucher identifier, the minimum purchase amount, and the discount amount in the first through third text boxes 428-432, respectively. The UI screen 408 further includes a second submit button 434. When the first user 102 selects the second submit button 434, the voucher details of the discount voucher are communicated to the payment network server 116.

Based on the first approval request communicated by the payment network server 116 to the first user device 104, the first service application 122 renders the UI screen 410 on the display of the first user device 104. The UI screen 410 includes a third message and seventh and eighth user-selectable options 436 and 438, respectively. The third message indicates an original purchase amount (i.e., the first purchase amount), the first discount amount, and the first payable amount after the discount voucher is applied. The first user 102 may provide consent or decline consent for the first purchase by selecting the seventh user-selectable option 436 or the eighth user-selectable option 438, respectively. When the first user 102 provides consent for the first purchase by selecting the seventh user-selectable option 436, the first user device 104 communicates the first approval response to the payment network server 116. After the discount voucher is redeemed and the first purchase is complete, the first service application 122 renders the UI screen 412 on the display of the first user device 104. The UI screen 412 includes a fourth message that is indicative of a successful completion of the first purchase. The UI screen 412 may be rendered after the first purchase notification is received by the first user device 104 from the payment network server 116.

It will be apparent to those of skill in the art that UI screens rendered when the first user 102 selects the sixth user-selectable option 426 for redeeming the gift voucher may be similar to the UI screens 402-412.

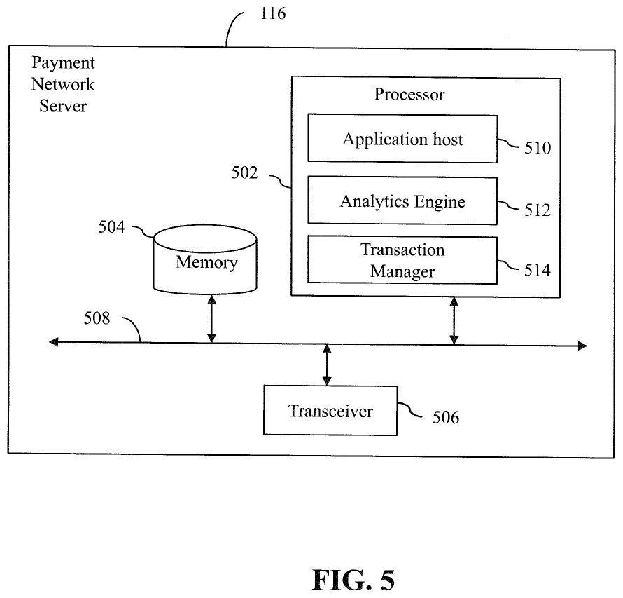

FIG. 5 is a block diagram that illustrates the payment network server 116, in accordance with an embodiment of the present invention. The payment network server 116 includes a processor 502, a memory 504, and a transceiver 506. The processor 502, the memory 504, and the transceiver 506 communicate with each other by way of a communication bus 508. The processor 502 includes an application host 510, an analytics engine 512, and a transaction manager 514. In one embodiment, the merchant server 114 may be implemented by the block diagram of FIG. 5 without deviating from the scope of the invention.

The processor 502 includes suitable logic, circuitry, interfaces, and/or codes, executed by the circuitry, to redeem vouchers (such as the first voucher) and facilitate purchases initiated by users (e.g., the first through third users 102, 106, and 110) by way of the first service application 122. The processor 502 stores, in the memory 504, account profiles of the users who are registered with the payment network server 116. For example, an account profile of the first user 102 may include payment credentials (e.g., the first transaction card details of the first transaction card) of the first user 102, authentication information of the first user 102, and/or the like. The processor 502 hosts the first service application 122 that is executable on the first, second, and third user devices 104, 108, and 112. The processor 502 may authenticate the first, second, and third users 102, 106, and 110 when the first, second, and third users 102, 106, and 110 attempt to log into the first service application 122.

Examples of the processor 502 may include, but are not limited to, an application-specific integrated circuit (ASIC) processor, a reduced instruction set computer (RISC) processor, a complex instruction set computer (CISC) processor, a field programmable gate array (FPGA), and the like. The processor 502 executes operations for redeeming vouchers and facilitating purchases by way of the application host 510, the analytics engine 512, and the transaction manager 514.

The application host 510 executes operations for hosting the first service application 122 that is executable on various devices, such as the first, second, and third user devices 104, 108, and 112. The application host 510 may control the first service application 122 and cause it to perform various operations (such as the rendering of the UI screens 402-412) as described in FIGS. 4A-4B. By way of the UI screens 402-412, the application host 510 allows users (e.g., the first user 102) to avail the VRS. By way of the UI screens 402-412, the application host 510 allows users (such as the first, second, and third users 102, 106, and 110) to pay for purchases (such as the first, second, and third purchases). The application host 510 stores voucher details (such as the voucher details of the discount and gift vouchers) provided by users (such as the first user 102) in the memory 504.

The analytics engine 512 receives various purchase requests (such as the first, second, and third purchase requests) from the merchant server 114. The analytics engine 512 also receives various voucher redemption requests for redeeming vouchers (such as the discount voucher and the gift voucher). As described in the foregoing description of FIGS. 2A-2F, the analytics engine 512 selects, based on the voucher details of the discount voucher, the purchases requests for redeeming the discount voucher, such that the sum of purchase amounts of the first purchase request and the selected purchase requests is greater than or equal to the minimum purchase amount of the discount voucher. As described in the foregoing description of FIGS. 3A-3F, the analytics engine 512 selects, based on the voucher details of the gift voucher, the purchase requests for redeeming the gift voucher (i.e., encashing the gift voucher). The analytics engine 512 may employ artificial intelligence to select the purchase requests. The artificial intelligence may also be used to determine discount amounts (such as the first, second, and third discount amounts) and credit amounts (such as the credit amount), wherever applicable. Further, the analytics engine 512 communicates with the merchant server 114 to validate the vouchers (such as the discount and gift vouchers).

The transaction manager 514 facilitates redemption of the vouchers (such as the discount and gift vouchers) and purchases of products and/or services from the first merchant. The transaction manager 514 generates and communicates funds transfer requests (such as the first, second, and third funds transfer requests) to issuers (such as the first issuer server 118) for transferring funds from payment accounts of the users to the fourth payment account. Further, the transaction manager 514 generates and communicates clubbed check-out requests (such as the first and second clubbed check-out requests) to the merchant server 114 for redeeming vouchers (such as the gift and discount vouchers) and completing purchases (such as the first, second, and third purchases).

The memory 504 includes suitable logic, circuitry, interfaces, and/or codes, executable by the circuitry, to store the account profiles of users (such as the first user 102) and voucher details of vouchers provided by the users. Examples of the memory 504 may include a random-access memory (RAM), a read-only memory (ROM), a removable storage drive, a hard disk drive (HDD), a flash memory, a solid-state memory, and the like. It will be apparent to a person skilled in the art that the scope of the invention is not limited to realizing the memory 504 in the payment network server 116, as described herein. In another embodiment, the memory 504 may be realized in form of a database server or a cloud storage working in conjunction with the payment network server 116, without departing from the scope of the invention.

The transceiver 506 includes suitable logic, circuitry, interfaces, and/or codes, executable by the circuitry, for transmitting and receiving data over the communication network 120 using one or more communication network protocols. The transceiver 506 transmits various requests and messages to the first, second, and third user devices 104, 108, and 112, the merchant server 114, and the first issuer server 118 The transceiver 506 further receives various requests and messages from the first, second, and third user devices 104, 108, and 112, the merchant server 114, and the first issuer server 118. Examples of the transceiver 506 may include, but are not limited to, an antenna, a radio frequency transceiver, a wireless transceiver, a Bluetooth transceiver, an ethernet port, a universal serial bus (USB) port, or any other device configured to transmit and receive data.

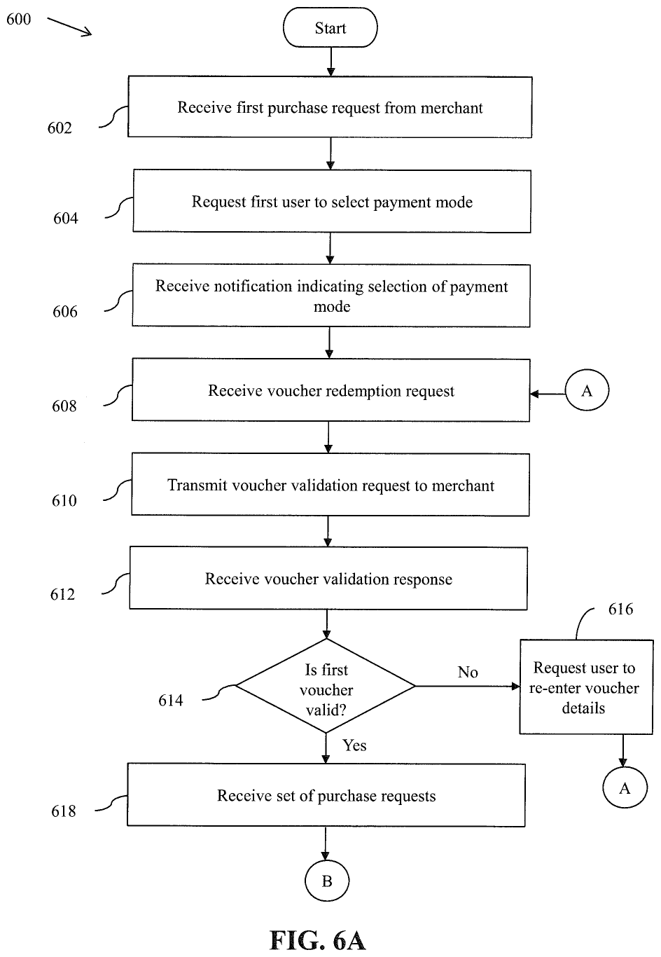

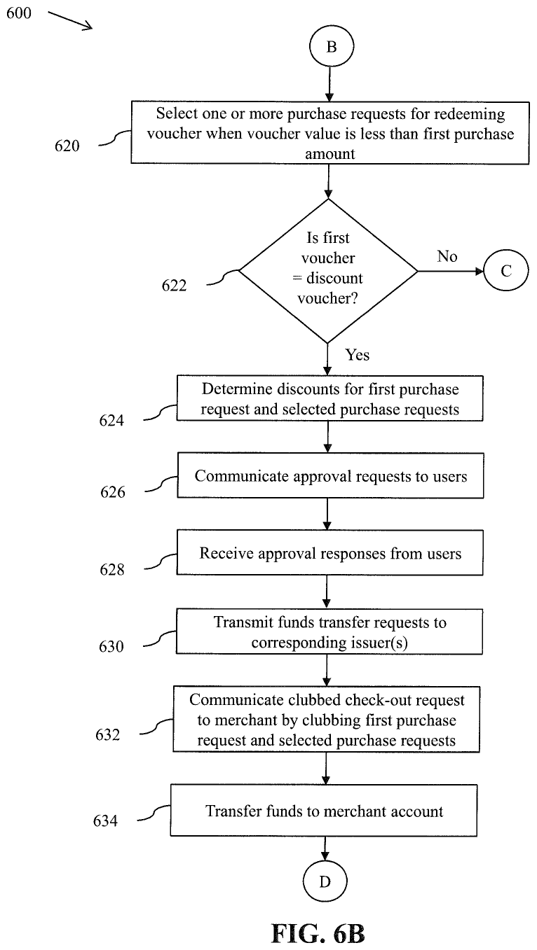

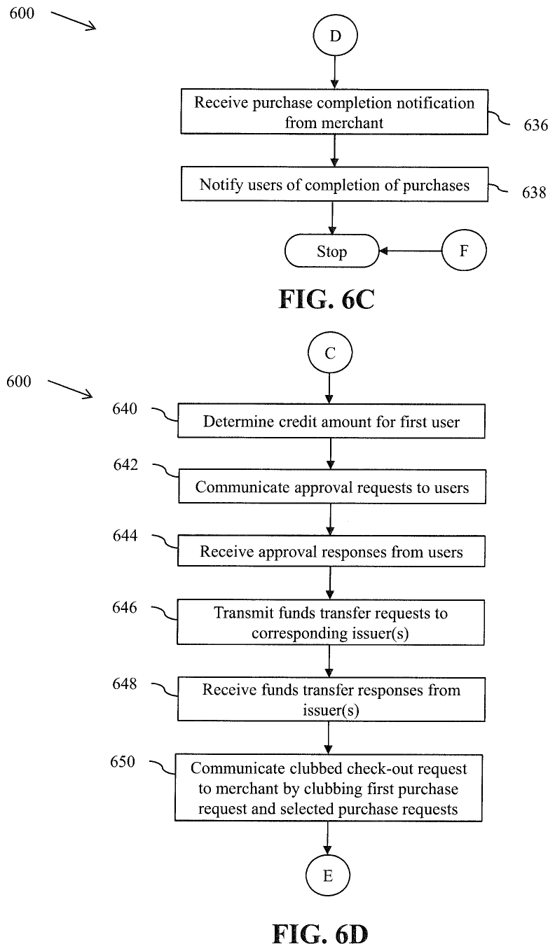

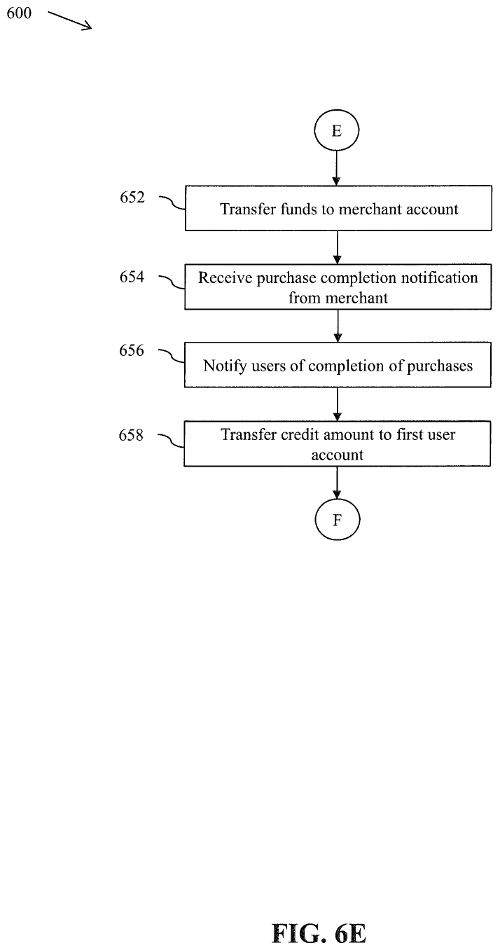

FIGS. 6A-6E, collectively represents a flow chart 600 that illustrates a method for redeeming vouchers, in accordance with an embodiment of the present invention. The first user 102 uses the second service application 124 to make a first purchase from the first merchant (as described in the foregoing description of FIGS. 2A-2F and 3A-3F). The first user 102 opts to pay for the first purchase by way of the first service application 122.

At step 602, the payment network server 116 receives a first purchase request, from the merchant server 114, for a first product that the first user 102 wants to purchase (as described in the foregoing descriptions of FIGS. 2B and 3B). The first purchase request may be indicative of a transaction reference number of the first purchase, a first purchase amount of the first purchase, a purchase category associated with the first purchase, or the like. At step 604, the payment network server 116 requests, by way of the first service application 122, the first user 102 to select a payment mode for the first purchase (as described in the foregoing descriptions of FIGS. 2B and 3B). In a non-limiting example, it is assumed that the first user 102 selects the first transaction card as the payment mode. At step 606, the payment network server 116 receives a notification, from the first user device 104, indicating the selection of the first transaction card as the payment mode. At step 608, the payment network server 116 receives, from the first user device 104, a voucher redemption request for redeeming the first voucher. The voucher redemption request includes voucher details of the first voucher (as described in the foregoing description of FIGS. 2B-2C and 3B-3C). At step 610, the payment network server 116 transmits a voucher validation request (such as the first and second voucher validation requests) to the merchant server 114 for validating the first voucher. The voucher validation request may include the voucher details of the first voucher. Based on the voucher details, the merchant server 114 may determine whether the first voucher is valid. The merchant server 114 transmits a voucher validation response (such as the first and second voucher validation responses) to the payment network server 116. The voucher validation response indicates whether the first voucher is valid.

At step 612, the payment network server 116 receives the voucher validation response. At step 614, the payment network server 116 determines, based on the voucher validation response, whether the first voucher is valid. If at step 614, it is determined that the first voucher is invalid, step 616 is performed. At step 616, the payment network server 116 communicates a message to the first user device 104 and performs step 608. The message indicates a voucher validation failure and requests the first user 102 to re-enter the voucher details of the first voucher. If at step 614, it is determined that the first voucher is valid, step 618 is performed.

At step 618, the payment network server 116 receives, from the merchant server 114, a set of purchase requests associated with other users (as described in the foregoing description of FIGS. 2C and 3C). At step 620, when the first purchase amount is less than a first voucher value of the first voucher, the payment network server 116 selects, from the set of purchase requests, one or more purchase requests. The payment network server 116 selects the one or more purchase requests such that a sum of the first purchase amount and purchase amounts associated with the selected purchase requests is greater than or equal to the first voucher value. The first voucher value is one of a minimum purchase amount associated with the first voucher or a gift amount associated with the first voucher. At step 622, the payment network server 116 determines if the first voucher is a discount voucher based on the first voucher details. If at step 622, it is determined that the first voucher is a discount voucher, step 624 is performed.

At step 624, the payment network server 116 determines discounts (e.g., the first, second, and third discount amounts) applicable on the first purchase request and the selected purchase requests (as described in the foregoing description of FIG. 2D). At step 626, the payment network server 116 communicates approval requests (such as the first, second, and third approval requests) to the first user device 104 and user devices (e.g., the second and third user devices 108 and 112) of users (e.g., the second and third users 106 and 110) corresponding to the selected purchase requests. Each approval request is indicative of a corresponding discount amount (such as the first, second, and third discount amounts) and a corresponding payable amount (such as the first, second, and third payable amounts) for a purchase request. Based on the approval requests, the first user 102 and the users corresponding to the selected purchase requests may provide consents or decline consents for the corresponding purchases. At step 628, the payment network server 116 receives approval responses (e.g., the first, second, and third approval responses) from the first user device 104 and the user devices of the users corresponding to the selected purchase requests. In a non-limiting example, it is assumed that the first user 102 and the users approve the corresponding purchases.

At step 630, the payment network server 116 communicates funds transfer requests to the first issuer server 118 (as described in the foregoing description of FIG. 2E). The funds transfer requests are for transferring funds to the fourth payment account of the payment network server 116 for making the first purchase and purchases corresponding to the selected purchase requests. In a non-limiting example, it is assumed that the funds are transferred to the fourth payment account. At step 632, the payment network server 116 communicates a clubbed check-out request (e.g., the first clubbed check-out request) to the merchant server 114 by clubbing the first purchase request and the selected purchase requests. The clubbed check-out request may include the voucher details of the first voucher for redeeming the first voucher against the clubbed purchase requests (i.e., against the first purchase request and the selected purchase requests). At step 634, the payment network server 116 transfers funds to the merchant account of the first merchant for completing the first purchase and the purchases corresponding to the selected purchase requests. At step 636, the payment network server 116 receives a purchase completion notification from the merchant server 114, indicating that the first purchase and the purchases corresponding to the selected purchase requests have been completed. At step 638, the payment network server 116 communicates purchase notifications to the first user device 104 and the user devices associated with the selected purchase requests to indicate that the first purchase and the one or more purchases, respectively, are complete.

If at step 622, it is determined that the first voucher is not a discount voucher (i.e., the first voucher is a gift voucher), step 640 is performed. At step 640, the payment network server 116 determines a credit amount that is to be credited to the user account of the first user 102 (as described in the foregoing description of FIG. 3D). At step 642, the payment network server 116 communicates approval requests (such as the fourth, fifth, and sixth approval requests) to the first user device 104 and user devices (e.g., the second and third user devices 108 and 112) of users (e.g., the second and third users 106 and 110) associated with the selected purchase requests (as described in the foregoing description of FIG. 3D). Based on the approval requests, the first user 102 and the one or more users may provide consents or decline consents for the corresponding purchases. At step 644, as described in the foregoing descriptions of FIG. 3D, the payment network server 116 receives approval responses (e.g., the fourth, fifth, and sixth approval responses) from the first user device 104 and the user devices of the users associated with the selected purchase requests. In a non-limiting example, it is assumed that the first user 102 and the users associated with the selected purchase requests have approved the corresponding purchases.

At step 646, the payment network server 116 communicates funds transfer requests (e.g., the fourth and fifth funds transfer requests) to the first issuer server 118 (as described in the foregoing description of FIG. 3E). The funds transfer requests are for transferring funds to the fourth payment account for making the first purchase and the purchases associated with the selected purchase requests. At step 648, the payment network server 116 receives funds transfer responses (e.g., fourth and fifth funds transfer responses) from the first issuer server 118. The funds transfer responses indicate whether funds have been transferred to the fourth payment account for making the first purchase and the purchases associated with the selected purchase requests. In a non-limiting example, it is assumed that the funds transfer responses indicate that the funds are transferred to the fourth payment account.

At step 650, the payment network server 116 communicates a clubbed check-out request (e.g., the second clubbed check-out request) to the merchant server 114 by clubbing the first purchase request and the selected purchase requests. The payment network server 116 communicates the clubbed check-out request for redeeming the first voucher against the clubbed purchases (i.e., against the first purchase request and the selected purchase requests). The clubbed check-out request may include the voucher details of the first voucher. At step 652, the payment network server 116 transfers funds to the merchant account of the first merchant for completing the first purchase and the purchases associated with the selected purchase requests. At step 654, the payment network server 116 receives a purchase completion notification from the merchant server 114, indicating that the first purchase and the purchases associated with the selected purchase requests have been completed. At step 656, the payment network server 116 communicates purchase notifications (e.g., the fourth purchase notification) to the first user device 104 and the user devices associated with the selected purchase requests to indicate that the first purchase and the purchases associated with the selected purchase requests, respectively, are complete. At step 658, the payment network server 116 transfers the credit amount to the first user account (e.g., the first payment account or the first digital wallet) of the first user 102.

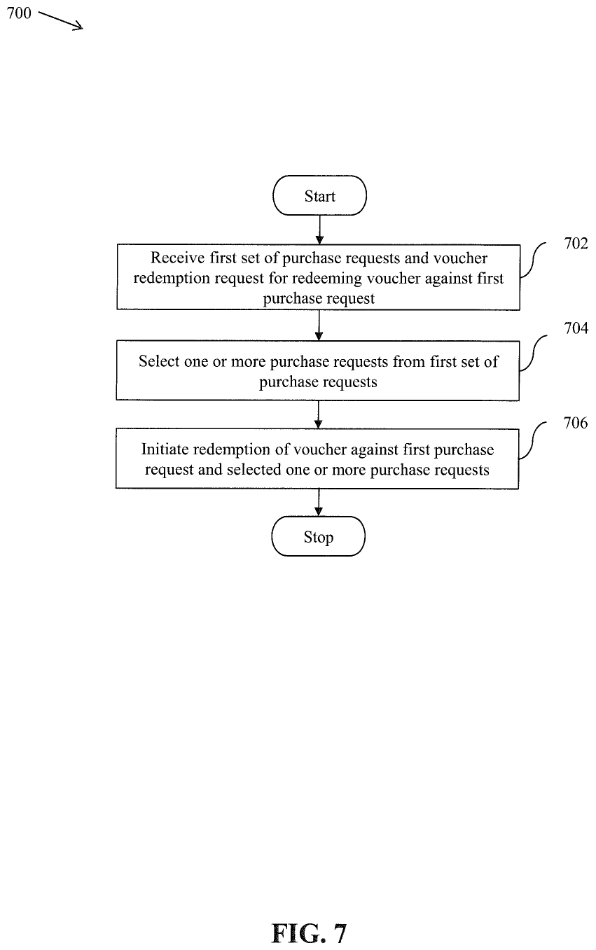

FIG. 7 represents a high-level flow chart 700 that illustrates the method for redeeming vouchers, in accordance with an embodiment of the present invention. At step 702, the payment network server 116 receives a first set of purchase requests for a first set of purchases and a voucher redemption request for redeeming a voucher (i.e., the first voucher) against a first purchase request. The first voucher is one of the discount voucher or the gift voucher. The first voucher is associated with the first voucher value (i.e., the minimum purchase amount or the gift amount). When the first voucher is the discount voucher, the first voucher value is the minimum purchase amount associated with the discount voucher. When the first voucher is the gift voucher, the first voucher value is the gift amount associated with the gift voucher. At step 704, the payment network server 116 selects, from the first set of purchase requests, one or more purchase requests such that a sum of a first purchase amount associated with the first purchase request and one or more purchase amounts associated with the selected one or more purchase requests is greater than or equal to the first voucher value. The payment network server 116 selects the one or more purchase requests when the first voucher value is greater than the first purchase amount. At step 706, the payment network server 116 initiates the redemption of the first voucher against the first purchase request and the selected one or more purchase requests.

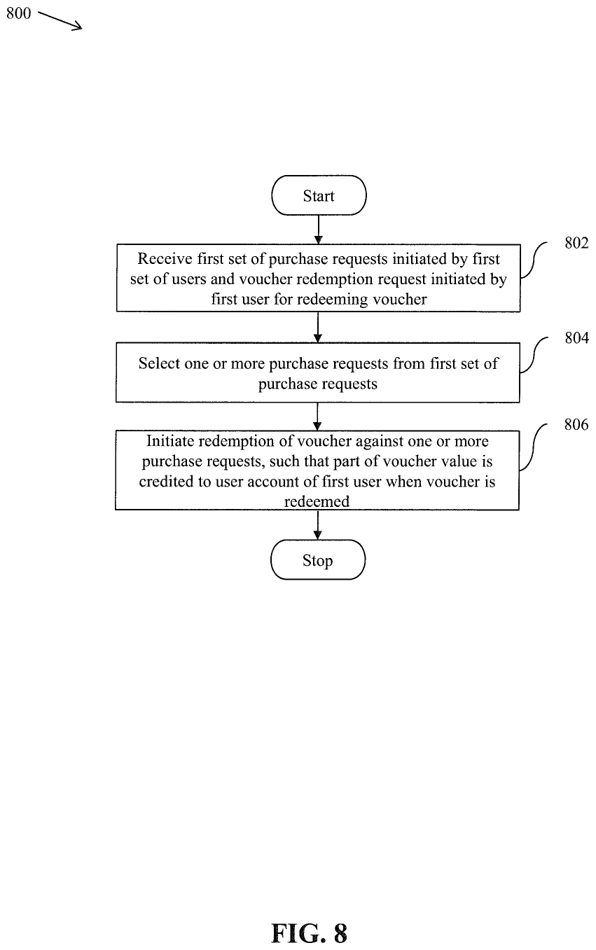

FIG. 8 represents a high-level flow chart 800 that illustrates the method for redeeming vouchers, in accordance with another embodiment of the present invention. At step 802, the payment network server 116 receives a first set of purchase requests initiated by a first set of users (e.g., the second and third users 106 and 110) and a voucher redemption request initiated by the first user 102 for redeeming the first voucher (i.e., the gift voucher). The first voucher is associated with the first voucher value (i.e., the gift amount). At step 804, the payment network server 116 selects, from the first set of purchase requests, one or more purchase requests. The payment network server 116 selects the one or more purchase requests such that a sum of one or more purchase amounts associated with the selected one or more purchase requests is greater than or equal to the first voucher value. At step 806, the payment network server 116 initiates the redemption of the first voucher against the one or more purchase requests, such that a part (i.e., the credit amount) of the voucher value is credited to a user account (e.g., the first user account and the first digital wallet) of the first user 102 when the voucher is redeemed.

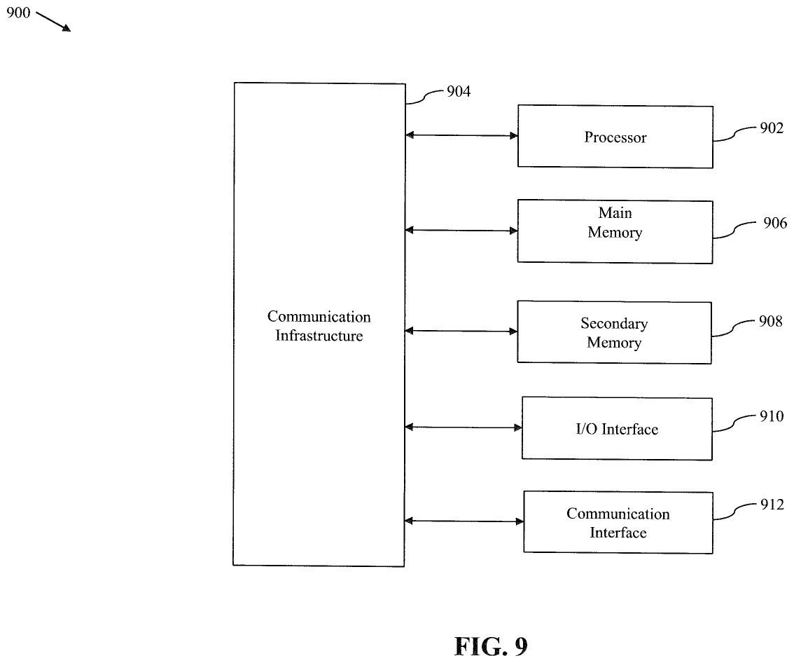

FIG. 9 is a block diagram that illustrates system architecture of a computer system 900, in accordance with an embodiment of the present invention. An embodiment of present invention, or portions thereof, may be implemented as computer readable code on the computer system 900. In one example, the first, second, and third user devices 104, 108, and 112, the merchant server 114, the payment network server 116, and the first issuer server 118 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 6A-6E, 7, and 8.

The computer system 900 includes a processor 902 that may be a special-purpose or a general-purpose processing device. The processor 902 may be a single processor, multiple processors, or combinations thereof. The processor 902 may have one or more processor cores. In one example, the processor 902 is an octa-core processor. The processor 902 may be connected to a communication infrastructure 904, such as a bus, message queue, multi-core message-passing scheme, and the like. The computer system 900 may further include a main memory 906 and a secondary memory 908. Examples of the main memory 906 may include RAM, ROM, and the like. The secondary memory 908 may include a hard disk drive or a removable storage drive, such as a floppy disk drive, a magnetic tape drive, a compact disc, an optical disk drive, a flash memory, and the like. The removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 900 further includes an input/output (I/O) interface 910 and a communication interface 912. The I/O interface 910 includes various input and output devices that are configured to communicate with the processor 902. Examples of the input devices may include a keyboard, a mouse, a joystick, a touchscreen, a microphone, and the like. Examples of the output devices may include a display screen, a speaker, headphones, and the like. The communication interface 912 may be configured to allow data to be transferred between the computer system 900 and various devices that are communicatively coupled to the computer system 900. Examples of the communication interface 912 may include a modem, a network interface, i.e., an Ethernet card, a communication port, and the like. Data transferred via the communication interface 912 may correspond to signals, such as electronic, electromagnetic, optical, or other signals as will be apparent to a person skilled in the art. The signals may travel via a communication channel (not shown) which may be configured to transmit the signals to devices that are communicatively coupled to the computer system 900. Examples of the communication channel may include, but are not limited to, cable, fiber optics, a phone line, a cellular phone link, a radio frequency link, and the like.

The main memory 906 and the secondary memory 908 may refer to non-transitory computer readable mediums. These to non-transitory computer readable mediums may provide data that enables the computer system 900 to implement the methods illustrated in FIGS. 6A-6E, 7, and 8. In an embodiment, the present invention is implemented using a computer implemented application, the computer implemented application may be stored in the main memory 906 and/or the secondary memory 908.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into digitally any device. For instance, at least one processor such as the processor 902 and a memory such as the main memory 906 and the secondary memory 908 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Thus, the environment 100 enhances a convenience of redeeming vouchers by allowing users (such as the first user 102) to avail the VRS. Technological improvements in the payment network server 116 enables the payment network server 116 to offer the VRS to various users. By way of the VRS, the first user 102 is able to redeem the discount voucher even when a first purchase amount of a first purchase is less than the minimum purchase amount of the discount voucher. The VRS also enables the first user 102 to encash the gift voucher with or without making a purchase. As the payment network server 116 applies the discount voucher on the selected purchase requests (e.g., the second and third purchase requests) along with the first purchase request, the first user 102 and other users corresponding to the selected purchase requests benefit monetarily (i.e., in terms of savings due to discounts). As a result of the application of the discounts, users may be more likely to purchase products and/or services, resulting in improved business for the first merchant. Further, entities (such as the merchant server 114 and the payment network server 116) offering the VRS can accrue monetary benefits by charging service fees for facilitating redemption of vouchers.

Techniques consistent with the present invention provide, among other features, systems and methods for redeeming vouchers. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method for redeeming vouchers, the method comprising:
receiving, by a server, a first set of purchase requests for a first set of purchases and a voucher redemption request for redeeming a voucher against a first purchase request, wherein the voucher is associated with a voucher value;
selecting, by the server from the first set of purchase requests, one or more purchase requests such that a sum of a first purchase amount associated with the first purchase request and one or more purchase amounts associated with the selected one or more purchase requests, respectively, is greater than or equal to the voucher value, wherein the one or more purchase requests are selected when the voucher value is greater than the first purchase amount; and
initiating, by the server, a redemption of the voucher against the first purchase request and the selected one or more purchase requests.

2. The method of claim 1, wherein the selected one or more purchase requests and the first purchase request are associated with the same purchase category.

3. The method of claim 1, further comprising verifying, by the server, an authenticity of the voucher prior to initiating the redemption of the voucher.

4. The method of claim 1, further comprising communicating, by the server, an approval request to each user associated with the one or more purchase requests for requesting an approval for redeeming the voucher, wherein the voucher is redeemed against the selected one or more purchase requests when each user provides the approval based on the approval request.

5. The method of claim 1, wherein the voucher is a discount voucher, and wherein the voucher value is a minimum purchase amount associated with the voucher.

6. The method of claim 5, wherein a first discount amount is deducted from the first purchase amount and a second discount amount is deducted from a second purchase amount, based on the redemption of the discount voucher, and wherein the second purchase amount is associated with a second purchase request of the selected one or more purchase requests.

7. The method of claim 1, wherein the voucher is a gift voucher, and wherein the voucher value is a gift amount associated with the voucher.

8. The method of claim 7, wherein a part of the voucher value is credited to a user account of a first user associated with the voucher redemption request when the voucher is redeemed.

9. A system for redeeming vouchers, the system comprising:
a server that is configured to:
receive a first set of purchase requests for a first set of purchases and a voucher redemption request for redeeming a voucher against a first purchase request, wherein the voucher is associated with a voucher value,
select from the first set of purchase requests, one or more purchase requests such that a sum of a first purchase amount associated with the first purchase request and one or more purchase amounts associated with the selected one or more purchase requests, respectively, is greater than or equal to the voucher value, wherein the one or more purchase requests are selected when the voucher value is greater than the first purchase amount, and
initiate a redemption of the voucher against the first purchase request and the selected one or more purchase requests.

10. The system of claim 9, wherein the selected one or more purchase requests and the first purchase request are associated with the same purchase category.

11. The system of claim 9, wherein the server is further configured to verify an authenticity of the voucher prior to initiating the redemption of the voucher.

12. The system of claim 9, wherein the server is further configured to communicate an approval request to each user associated with the one or more purchase requests for requesting an approval for redeeming the voucher, and wherein the voucher is redeemed against the selected one or more purchase requests when each user provides the approval based on the approval request.

13. The system of claim 9, wherein the voucher is a discount voucher, and wherein the voucher value is a minimum purchase amount associated with the voucher.

14. The system of claim 9, wherein the voucher is a gift voucher, and wherein the voucher value is a gift amount associated with the voucher.

15. The system of claim 14, wherein a part of the voucher value is credited to a user account of a first user associated with the voucher redemption request when the voucher is redeemed.

16. A method for redeeming vouchers, the method comprising:
receiving, by a server, a first set of purchase requests initiated by a first set of users and a voucher redemption request initiated by a first user for redeeming a voucher, wherein the voucher is associated with a voucher value;
selecting, by the server from the first set of purchase requests, one or more purchase requests such that a sum of one or more purchase amounts associated with the selected one or more purchase requests, respectively, is greater than or equal to the voucher value; and
initiating, by the server, a redemption of the voucher against the selected one or more purchase requests, wherein a first part of the voucher value is credited to a first user account of the first user when the voucher is redeemed.

17. The method of claim 16, wherein the voucher is a gift voucher, and wherein the voucher value is a gift amount associated with the voucher.

18. The method of claim 16, further comprising communicating, by the server, an approval request to each user associated with the one or more purchase requests for requesting an approval for redeeming the voucher, wherein the voucher is redeemed against the selected one or more purchase requests when each user provides the approval based on the approval request.

19. The method of claim 16, further comprising verifying, by the server, an authenticity of the voucher prior to initiating the redemption of the voucher.

20. The method of claim 16, wherein the first set of users is exclusive of the first user, wherein a second part of the voucher value is credited to a second user account of a second user when the voucher is redeemed, and wherein the first set of users includes the second user.
